(19) United States
(12) Patent Application Publication
(10) Pub. No.: US 2014/0154556 A1
(43) Pub. Date: Jun. 5, 2014

(54) BATTERY MODULE

(71) Applicant: Toru Suzuki, Sagamihara-shi (JP)

(72) Inventor: Toru Suzuki, Sagamihara-shi (JP)

(73) Assignee: NEC ENERGY DEVICES, LTD., Sagamihara-shi, Kanagawa (JP)

(21) Appl. No.: 14/232,823

(22) PCT Filed: May 29, 2012
(86) PCT No.: PCT/JP2012/063807

§ 371 Date: Jan. 14, 2014

(30) Foreign Application Priority Data
Jul. 15, 2011 (JP) 2011-156735

(51) Int. Cl. H01M 10/6555

(52) U.S. Cl. CPC H01M 10/5055
USPC 429/154

(57) ABSTRACT

To provide a large-capacity battery module that easily can ensure a high level of flame retardancy, a battery module of the present invention includes: an assembled battery in which a plurality of sheet-like unit batteries are stacked; a flat-plate base that includes a front surface and a back surface as two main surfaces; and a peripheral partition wall section (211) that is erected and provided in a peripheral section of the front or back surface from the base, and is formed on both the front and back surfaces, wherein, in a region formed by the base and the peripheral partition wall section (211), at least the one assembled battery is housed.

### TECHNICAL FIELD

The present invention relates to a battery module that is made by using secondary unit batteries such as lithium-ion batteries.

### BACKGROUND ART

In recent years, in light of environmental issues, much attention has been paid to clean energy obtained from wind power generation, solar power generation, and the like, which can be used for households, such as detached houses, as well as for industries, such as transport machines and construction machines. However, the problem with clean energy is that the output varies widely depending on the situation. For example, the energy generated by solar power can be obtained during the day when the sun is out, but cannot be obtained during the night after the sun went down.

In order to ensure stable output of clean energy, what is used is a technique for temporarily storing the clean energy in batteries. For example, solar energy stored in batteries is available even during the night after the sun went down. As the batteries that store the clean energy, lead-acid batteries are typically used. However, the disadvantage is that typical lead-acid batteries are large in size, and are low in energy density.

In recent years, lithium-ion secondary batteries that can operate at normal temperatures and are high in energy density have been gaining attention. The lithium-ion secondary batteries are characterized as being high in energy density, as well as being excellent in responsiveness because of low impedance.

As lithium-ion secondary batteries, for example, there is a laminate battery in which battery elements are enclosed inside a flexible film. The laminate battery usually is a flat plate, with positive and negative electrodes pulled out of the flexible film.

What is known is a technique for connecting two or more such laminate batteries in series and putting the laminate batteries in a container body (casing) to make a module, which is suitable for large capacity.

For example, what is disclosed in Patent Document 1 (Japanese Patent No. 3,970,684) is a battery module that includes an assembled battery that is made by connecting together four sheet-like secondary battery cells, which are formed into a sheet, in series, and a thin, rectangular-parallelepiped-shaped casing that houses the assembled battery.
Patent Document 1: Japanese Patent No. 3,970,684

### SUMMARY OF THE INVENTION

### Problems to be Solved by the Invention

The lithium-ion secondary batteries are higher in energy density than other batteries. Therefore, to ensure safety, an especially high level of flame retardancy is required. The flame retardancy of the batteries can be enhanced by using highly flame-retardant electrode materials or improving the configuration of unit batteries. However, the configuration of a battery module in which the unit batteries are stored, too, is greatly required to be high in flame retardancy.

However, in the case of the battery module disclosed in Patent Document 1, when two secondary battery cells are used to make an assembled battery, the battery module has a structure in which seal sections of a bag-shaped exterior body overlap with each other. Therefore, abnormal heating or any other trouble of one battery is likely to affect another battery. Thus, the problem is how to ensure a high level of flame retardancy as a structure of the battery module.

Accordingly, the object of the present invention is to provide a battery module that is so configured as to be able to easily have a high level of flame retardancy.

### Means for Solving the Problems

The present invention has been made to solve the above problems. A battery module of the present invention includes: an assembled battery in which a plurality of sheet-like unit batteries are stacked; a flat-plate base that includes a front surface and a back surface as two main surfaces; and a peripheral partition wall section that is erected and provided in a peripheral section of the front or back surface from the base, and is formed on both the front and back surfaces, wherein, in a region formed by the base and the peripheral partition wall section, at least the one assembled battery is housed.

In the battery module of the present invention, the assembled battery is formed by connecting the plurality of sheet-like unit batteries stacked in parallel.

In the battery module of the present invention, the assembled battery is housed in each of the regions provided on the front surface and the back surface.

The battery module of the present invention includes a bus bar through which the plurality of assembled batteries are connected in series.

The battery module of the present invention includes a bus bar that connects at least one assembled battery that is provided on the front surface's side of the base to at least one assembled battery that is provided on the back surface of the base.

The battery module of the present invention includes a protruding guide member that is provided on two side faces that are different from the front and back surfaces and face each other, in such a way as to extend along a planar direction of the front or back surface.

In the battery module of the present invention, the protruding guide member is so provided as to protrude from the peripheral partition wall section or to extend from the base; and a tapered section is so provided that a protruding amount of the protruding, or an extending amount of the extending, varies.

In the battery module of the present invention, a width of the protruding guide member provided on one of the two side faces is different from a width of the protruding guide member provided on the other side face in a direction perpendicular to the front or back surface.

### Advantages of the Invention

In the battery module of the present invention, a compartmentalization partition wall section that is provided outside a peripheral section of each of the assembled batteries helps to keep abnormal heating or any other trouble of one battery from affecting other batteries. Therefore, it is possible to provide the large-capacity battery module that easily can ensure a high level of flame retardancy.

### BRIEF DESCRIPTION OF THE DRAWINGS

FIG. 1 is a diagram showing a unit battery 100 that constitutes a battery module according to an embodiment of the present invention, and a preliminary processing step thereof.

FIG. 2 is a diagram illustrating a battery housing body 200 that is used in making a battery module according to an embodiment of the present invention.

FIG. 3 is a diagram illustrating a battery housing body 200 that is used in making a battery module according to an embodiment of the present invention.

FIG. 4 is a diagram illustrating a production process of a battery module according to an embodiment of the present invention.

FIG. 5 is a diagram illustrating a production process of a battery module according to an embodiment of the present invention.

FIG. 6 is a diagram illustrating a production process of a battery module according to an embodiment of the present invention.

FIG. 7 is a diagram illustrating a production process of a battery module according to an embodiment of the present invention.

FIG. 8 is a diagram illustrating a first surface cover body 310 that is used in making a battery module according to an embodiment of the present invention.

FIG. 9 is a diagram illustrating a second surface cover body 320 that is used in making a battery module according to an embodiment of the present invention.

FIG. 10 is a diagram showing a preliminary processing step of a cover body that constitutes a battery module according to an embodiment of the present invention.

FIG. 11 is a diagram illustrating a cover body insulation sheet 360 that is used in making a battery module according to an embodiment of the present invention.

FIG. 12 is a diagram showing a preliminary processing step of a cover body that constitutes a battery module according to an embodiment of the present invention.

FIG. 13 is a diagram illustrating a production process of a battery module according to an embodiment of the present invention.

FIG. 14 is a diagram showing a battery module 400 according to an embodiment of the present invention.

FIG. 15 is a diagram illustrating a production process of a battery module according to an embodiment of the present invention.

FIG. 16 is a diagram illustrating a production process of a battery module according to an embodiment of the present invention.

FIG. 17 is a diagram showing a preliminary processing step of a cover body that constitutes a battery module according to an embodiment of the present invention.

FIG. 18 is a diagram illustrating a production process of a battery management circuit unit 500.

FIG. 19 is a diagram illustrating a production process of a battery management circuit unit 500.

FIG. 20 is a diagram illustrating a production process of a battery management circuit unit 500.

FIG. 21 is a diagram showing a battery management circuit unit 500.

FIG. 22 is a diagram outlining an electric storage device 600 that uses a battery module 400 according to an embodiment of the present invention.

FIG. 23 is a diagram illustrating an assembled battery that includes unit batteries 100 connected in parallel for making a battery module 400 according to another embodiment of the present invention.

FIG. 24 is a diagram showing an assembled battery in which unit batteries 100 are connected in parallel.

FIG. 25 is a diagram showing a battery module 700 according to a second embodiment of the present invention.

FIG. 26 is a cross-sectional view of a battery housing body 200 that is used in making a battery module according to an embodiment of the present invention.

FIG. 27 is a cross-sectional view of a battery housing body 200 that is used in making a battery module according to an embodiment of the present invention.

FIG. 28 is a cross-sectional view of a battery housing body 200 that is used in making a battery module according to an embodiment of the present invention.

FIG. 29 is a cross-sectional view of a battery housing body 200 that is used in making a battery module according to an embodiment of the present invention.

FIG. 30 is a diagram illustrating portions shown in cross section of a battery housing body 200.

FIG. 31 is a cross-sectional view of a battery module 400 according to an embodiment of the present invention.

### EMBODIMENTS FOR CARRYING OUT THE INVENTION

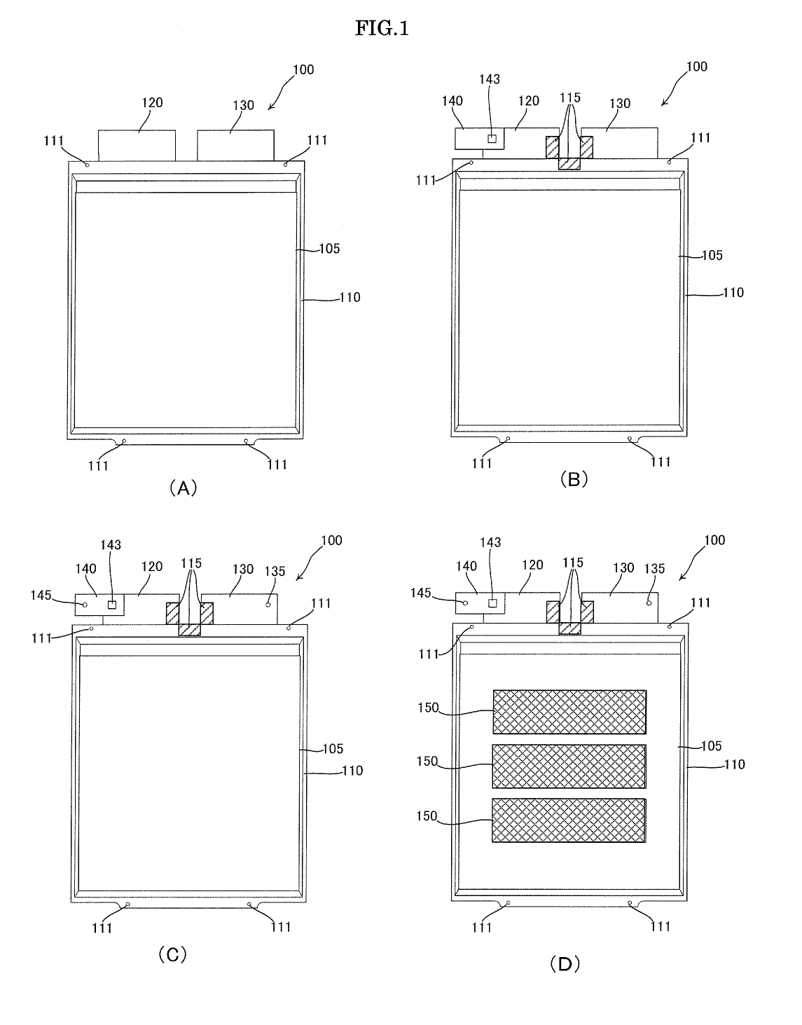

Hereinafter, an embodiment of the present invention will be described with reference to the accompanying drawings. FIG. 1 is a diagram showing a unit battery 100 that constitutes a battery module according to an embodiment of the present invention, and a preliminary processing step thereof. As the unit battery 100, a lithium-ion secondary unit battery, in which lithium ions move between a positive electrode and a negative electrode for charging and discharging, is used.

A battery body section 110 of the unit battery 100 has a structure in which an electrode stacked body and an electrolytic solution (both not shown in the diagram) are housed in a laminate film outer casing that is rectangular in planar view: In the electrode stacked body, a plurality of sheet-like positive electrodes and a plurality of sheet-like negative electrodes are stacked via separators. From one end portion of the battery body section 110, a positive electrode pulled-out tab 120 and a negative electrode pulled-out tab 130 are pulled out. A stacking direction in which a plurality of sheet-like positive electrodes and a plurality of sheet-like negative electrodes are stacked via separators as described above is defined as a sheet thickness direction.

Both the positive electrode pulled-out tab 120 and the negative electrode pulled-out tab 130 are planar in shape; in the laminate film outer casing, the positive electrode pulled-out tab 120 and the negative electrode pulled-out tab 130 each are connected directly, or via a lead body or the like, to a sheet-like positive electrode and a sheet-like negative electrode. The laminate film outer casing is made from metal laminate film with a heat-sealing resin layer. More specifically, for example, two metal laminate films are put together in such a way that the heat-sealing resin layers face each other, thereby forming a laminate film outer casing. An electrode stacked body having the sheet-like positive electrodes, sheet-like negative electrodes, and separators, and the electrolytic solution are housed inside, and the outer periphery of the laminate film outer casing is heat-sealed. Therefore, the inside thereof is sealed.

Here, metal pieces, such as the positive electrode pulled-out tab 120 and negative electrode pulled-out tab 130 that are pulled out of the battery body section 110 including the laminate film outer casing, are referred to as “pulled-out tabs.” Sheet-like positive and negative electrodes, which are stacked via separators, electrolytic solution, and the like in the laminate film outer casing, are referred to as “electrodes.”

Incidentally, the electrode stacked bodies include the above one in which a plurality of sheet-like positive electrodes and a plurality of sheet-like negative electrodes are stacked via separators, and a stack in which sheet-like positive electrodes and sheet-like negative electrodes are stacked via separators and wound around and are compressed.

In the above unit battery 100, as the material of the positive electrode pulled-out tab 120, aluminum or aluminum alloy is typically used. As the material of the negative electrode pulled-out tab 130, nickel, a material made by plating other metals with nickel (Nickel-plated material; e.g. copper plated with nickel, and the like), or a clad of nickel and other metals (Nickel-clad material; e.g. nickel-copper clad and the like) is typically used. According to the present embodiment, the positive electrode pulled-out tab 120 made of aluminum, and the negative electrode pulled-out tab 130 made of copper plated with nickel are used.

To the unit battery 100 having the above configuration, preliminary processing is carried out before a process of being incorporated into a battery module. First, as shown in FIG. 1(A), at four locations of the laminate film outer casing in a peripheral portion of the unit battery 100, alignment through-holes 111 are provided. The alignment through-holes 111 are used at subsequent steps where the unit battery 100 is set in the battery housing body 200.

In the battery housing body 200, unit-battery alignment projections 241 are provided. When the unit battery 100 is placed onto the battery housing body 200, the unit-battery alignment projections 241 are inserted into the alignment through-holes 111, which makes it easier for the unit battery 100 to be set into the battery housing body 200, helping improve production efficiency.

Then, in a process of FIG. 1(B), insulation tape 115 is affixed to three locations in all, i.e. two locations on the positive electrode pulled-out tab 120 and the negative electrode pulled-out tab 130 and one location of the laminate film outer casing between the positive electrode pulled-out tab 120 and the negative electrode pulled-out tab 130, thereby ensuring a more reliable level of insulation.

Moreover, in the process of FIG. 1(B), an additional tab member 140, which is made of copper, is ultrasonic-welded in a welding section 143. Therefore, the additional tab member 140 is connected to the positive electrode pulled-out tab 120. The reason why such an additional tab member 140 is used will be described.

In making a battery module of the present invention, the positive electrode pulled-out tab 120 of a unit battery 100 and the negative electrode pulled-out tab 130 of a unit battery 100 adjacent to the above unit battery 100 are mechanically fixed to a copper bus bar with screws, and therefore are electrically connected.

If the positive electrode pulled-out tab 120 containing aluminum of the unit battery 100 is mechanically fixed to the copper bus bar, the conductivity might deteriorate after certain years due to a difference in potential.

In the battery module of the present invention, as described above, to the positive electrode pulled-out tab 120 of the unit battery 100, the additional tab member 140 made of copper is welded. Then, the additional tab member 140 made of copper is mechanically fixed to the bus bar. In this manner, the problem of conductivity deterioration caused by the potential difference can be solved. According to the above configuration, in the mechanical electric connection section, the same kinds of metal material are electrically connected, not causing the problem of potential difference; the conductivity is unlikely to deteriorate over years.

Then, in a process of FIG. 1(C), in the additional tab member 140 that is added to the positive electrode pulled-out tab 120, a through-hole 145 is provided, and, in the negative electrode pulled-out tab 130, a through-hole 135 is provided. The through-holes, as described later, are used to: (1) mechanically fix the unit battery 100 to the unit battery housing body 200; (2) electrically connect the tabs to the bus bar of the unit battery housing body 200; and (3) electrically connect the tabs and a sense line.

Then, in a process of FIG. 1(D), two-sided tape 150 is affixed to the battery body section 110 of the unit battery 100. Three strips of two-sided tape 150 are affixed to each surface of the battery body section 110, i.e. six strips in total on both surfaces. A plane of the two-sided tape 150 that is not affixed to the unit battery 100 is affixed to the unit battery housing body 200 or to a cover body insulation sheet of a cover body. Therefore, the unit battery 100 is positionally fixed in the battery module.

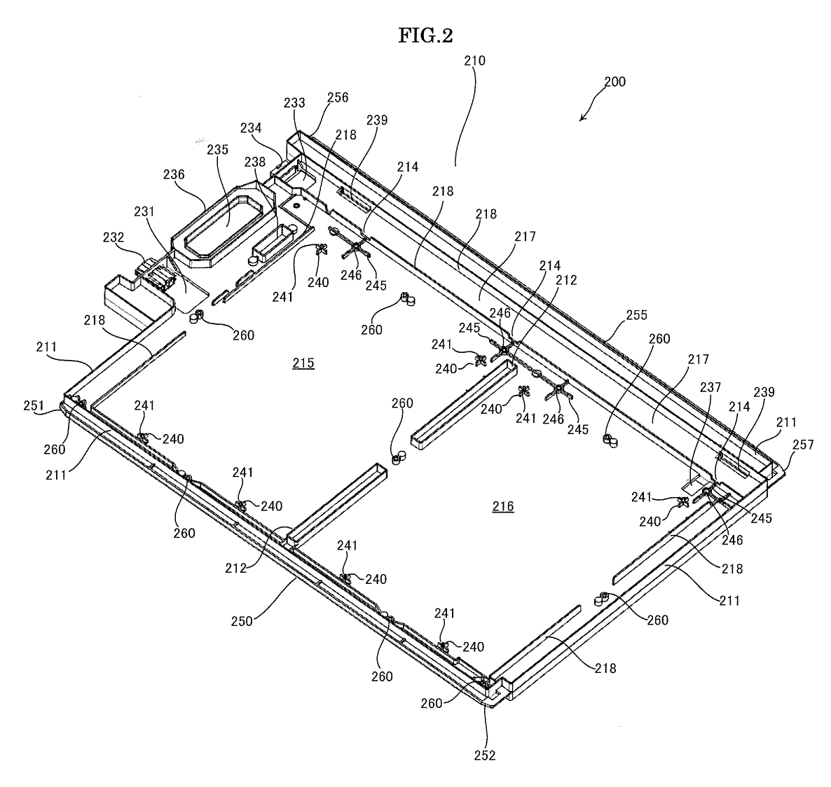

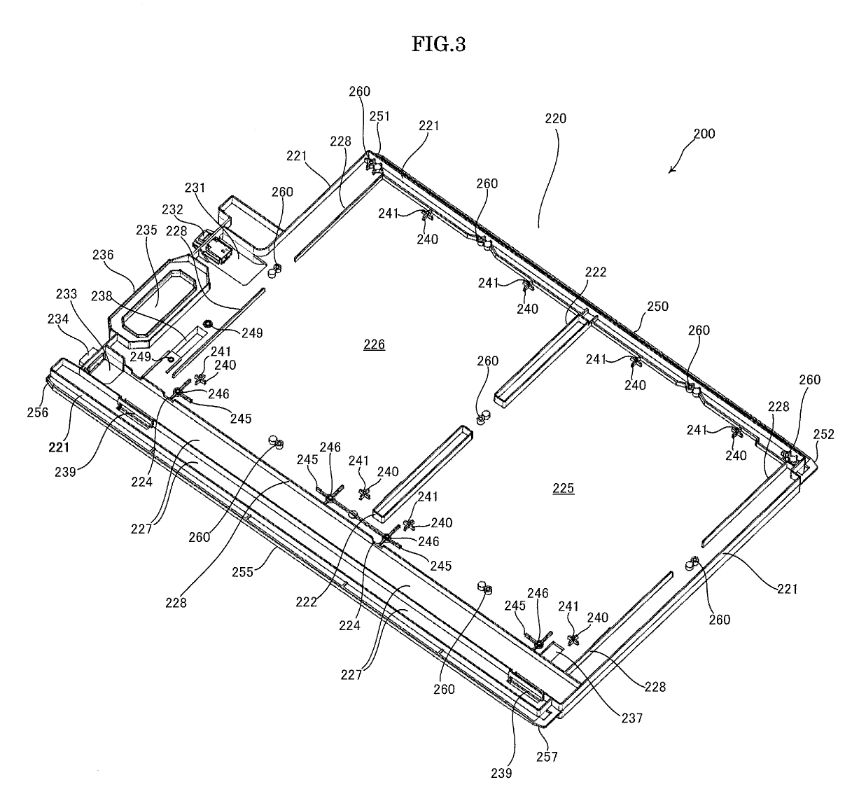

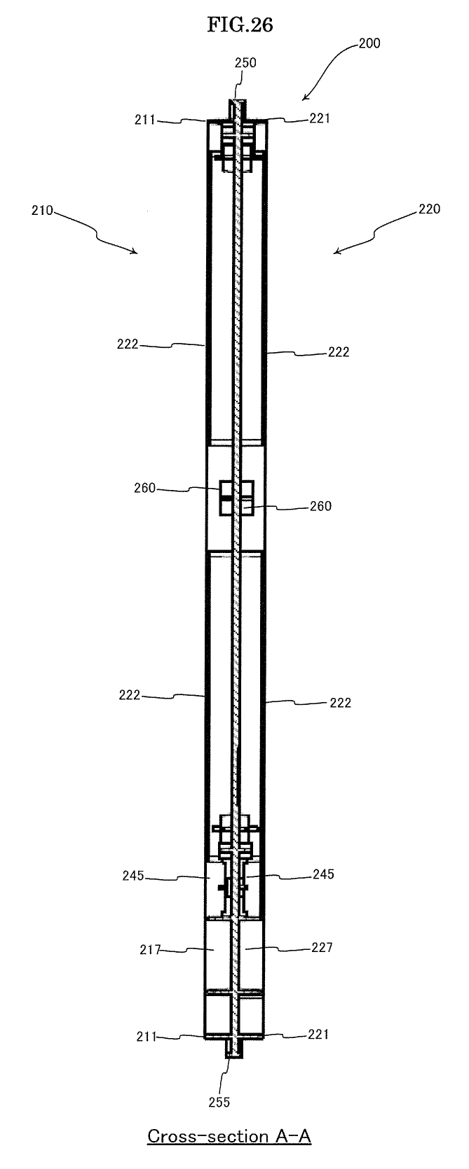

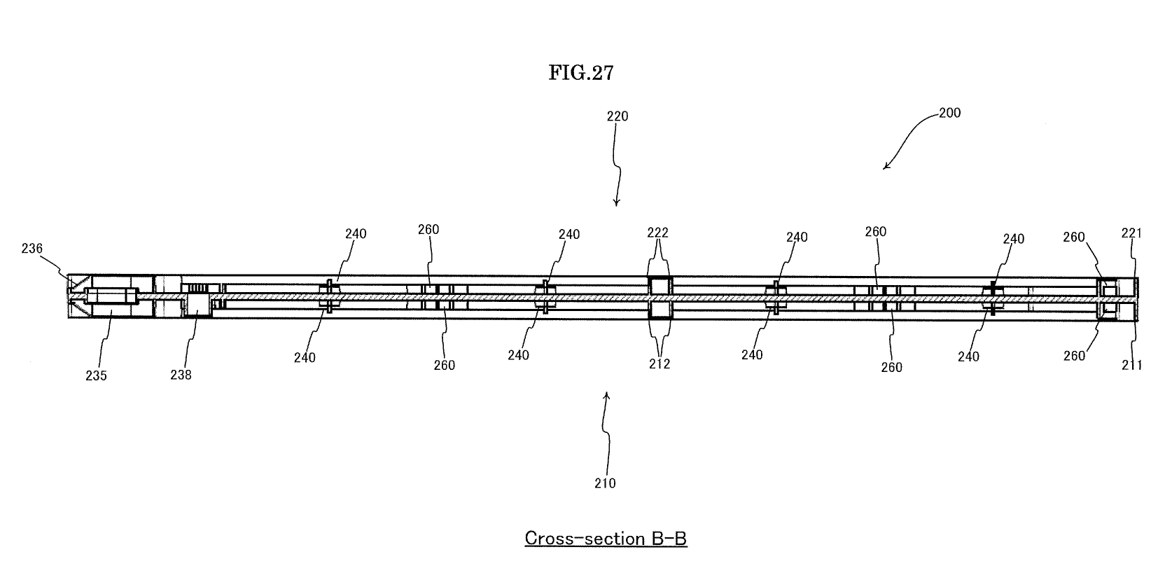

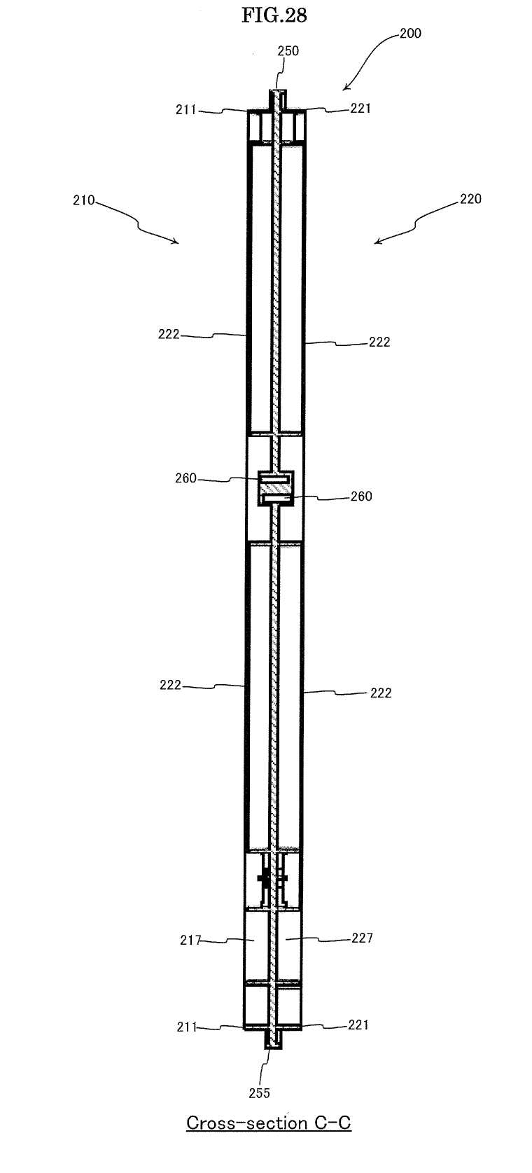

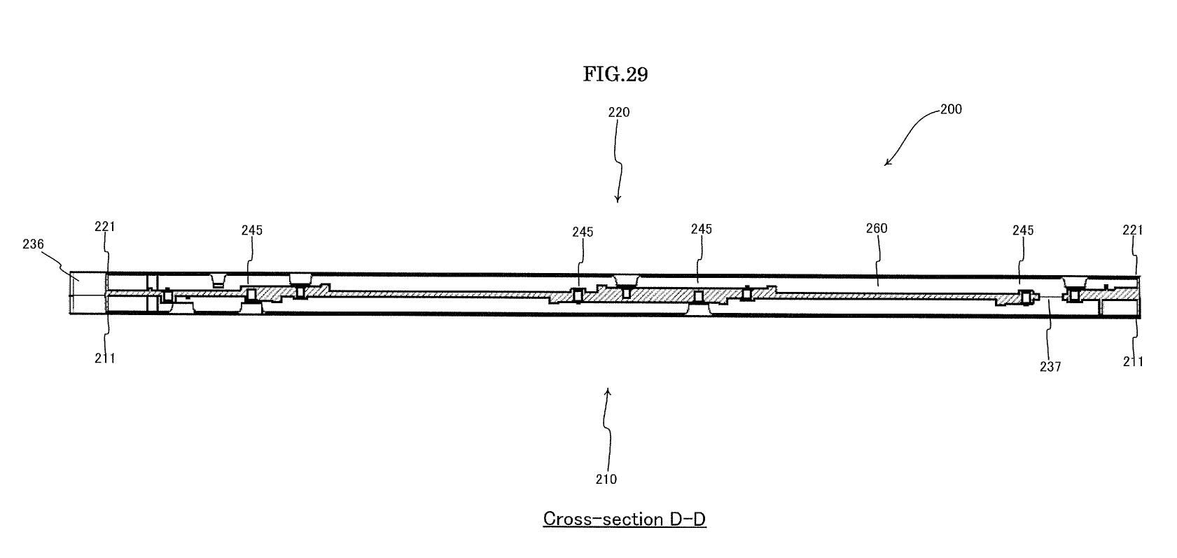

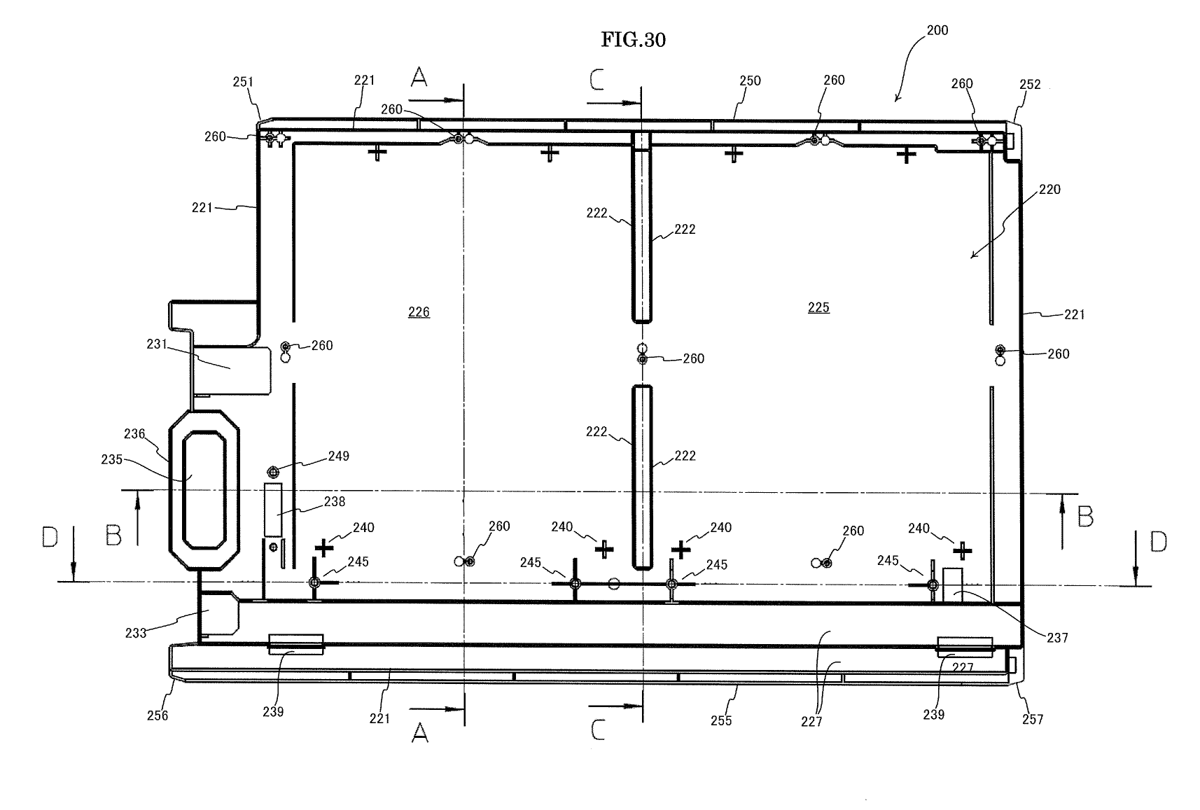

The configuration of the unit battery housing body 200, which houses unit batteries 100 that have been preliminarily processed as described above, will be detailed. FIGS. 2 and 3 are diagrams illustrating the battery housing body 200 that is used in making the battery module according to the embodiment of the present invention. FIGS. 26 to 29 are cross-sectional views of the battery housing body 200. FIG. 30 is a diagram illustrating which part of the battery housing body 200 is shown in the cross-sectional views of FIGS. 26 to 29. FIG. 26 is a cross-sectional view of FIG. 30 taken along A-A. FIG. 27 is a cross-sectional view of FIG. 30 taken along B-B. FIG. 28 is a cross-sectional view of FIG. 30 taken along C-C. FIG. 29 is a cross-sectional view of FIG. 30 taken along D-D.

The battery housing body 200 is a member made of synthetic resin such as ABS. In the battery housing body 200, the unit batteries 100 and other parts are mounted; the unit batteries 100 and other parts are connected together by wiring.

The battery housing body 200 includes a flat-plate base, and peripheral partition wall sections, which are formed in peripheral portions of front and back surfaces, which are two main surfaces of the base. The peripheral partition wall sections includes a first surface peripheral partition wall section, which is provided on the front surface of the base, and a second surface peripheral partition wall section, which is provided on the back surface of the base. FIG. 2 is a perspective view of the front surface of the base of the battery housing body 200. FIG. 3 is a perspective view of the back surface of the base of the battery housing body 200. In the following description, a main surface of the battery housing body on the base front surface's side shown in FIG. 2 is referred to as a first surface 210; a main surface of the battery housing body on the base back surface's side shown in FIG. 3 is referred to as a second surface 220.

On the first surface 210, a first surface peripheral partition wall section 211 is erected vertically on the front surface of the base in such a way as to surround the periphery of the front surface of the base. An inner area surrounded by the first surface peripheral partition wall section 211 is covered with a cover body described later.

In the inner area surrounded by the first surface peripheral partition wall section 211 on the first surface 210, first surface compartmentalization partition wall sections 212 are erected vertically on the front surface of the base, forming a partition wall between adjacent unit batteries 100 within the first surface. Moreover, first surface compartmentalization partition wall sections 218 are provided, too, to partition the space into housing chambers, in which unit batteries 100 are housed, and the like, along with the first surface compartmentalization partition wall sections 212.

On the first surface 210, mainly by the above first surface compartmentalization partition wall sections 212 and first surface compartmentalization partition wall sections 218, the following chambers are formed: a first battery housing chamber 215 and a second battery housing chamber 216, which are housing chambers that house unit batteries 100; and a first surface wiring housing chamber 217, which is a housing chamber that houses a sense line that is used to detect potential of a tab of a unit battery 100.

On the above first surface compartmentalization partition wall sections 218, wire-laying notch sections 214, where the height of the wall section is lower than other portions, are provided, making it possible to lay the sense line or the like from one housing chamber to the other housing chamber.

Similarly, on the second surface 220, a second surface peripheral partition wall section 221 is erected vertically on the back surface of the base in such a way as to surround the periphery of the back surface of the base. An inner area surrounded by the second surface peripheral partition wall section 211 is covered with a cover body described later.

In the inner area surrounded by the second surface peripheral partition wall section 221 on the second surface 220, second surface compartmentalization partition wall sections 222 are erected vertically on the back surface of the base, forming a partition wall between adjacent unit batteries 100 within the second surface. Moreover, second surface compartmentalization partition wall sections 228 are provided, too, to partition the space into housing chambers, in which unit batteries 100 are housed, and the like, along with the second surface compartmentalization partition wall sections 222.

On the second surface 220, mainly by the above second surface compartmentalization partition wall sections 222 and second surface compartmentalization partition wall sections 228, the following chambers are formed: a third battery housing chamber 225 and a fourth battery housing chamber 226, which are housing chambers that house unit batteries 100; and a second surface wiring housing chamber 227, which is a housing chamber that houses a sense line that is used to detect potential of a tab of a unit battery 100.

On the above second surface compartmentalization partition wall sections 228, wire-laying notch sections 224, where the height of the wall section is lower than other portions, are provided, making it possible to lay the sense line or the like from one housing chamber to the other housing chamber.

As described above, the unit battery housing body 200 has two housing chambers for unit batteries 100, i.e. the first battery housing chamber 215 and the second battery housing chamber 216, on the first surface 210; the unit battery housing body 200 has two housing chambers for unit batteries 100, i.e. the third battery housing chamber 225 and the fourth battery housing chamber 226, on the second surface 220. In total, the unit battery housing body 200 has four chambers for unit batteries 100 on both surfaces. If one battery housing chamber houses one unit battery 100, the unit battery housing body 200 of the present embodiment can house up to four unit batteries 100. Incidentally, in the battery module of the present invention, the number of unit batteries 100 that the unit battery housing body 200 can house is not limited to this example. If both sides of the unit battery housing body 200 are utilized, any given number of unit batteries 100 can be housed in the unit battery housing body 200.

In one end portion (or end portion on a side where the first battery housing chamber 215 and the fourth battery housing chamber 226 are disposed) of the unit battery housing body 200, a first through-hole 231 is provided. Between the first through-hole 231 and peripheral partition wall sections of the first surface peripheral partition wall section 211 and second surface peripheral partition wall section 221, a first connector 232 is provided. Through the first connector 232, power supply of unit batteries 100 connected in series can be taken out.

To the first connector 232, a power supply line coming from a unit battery 100 housed on the first surface 210, and a power supply line coming from a unit battery 100 housed on the second surface 220 are connected. Therefore, it is preferred that the above first through-hole 231 be provided so as to pass through between the first surface 210 and the second surface 220.

Moreover, the first through-hole 231 offers space for an operation of connecting a power supply line coming from a unit battery 100 to the first connector 232, and is therefore effective in terms of production efficiency.

Similarly, in one end portion (or end portion on a side where the first battery housing chamber 215 and the fourth battery housing chamber 226 are disposed) of the unit battery housing body 200, a second through-hole 233 is provided. Between the second through-hole 233 and peripheral partition wall sections of the first surface peripheral partition wall section 211 and second surface peripheral partition wall section 221, a second connector 234 is provided. Through the second connector 234, potential information of a tab of each of unit batteries 100 connected in series can be taken out. The potential information of a tab of each of unit batteries 100 enables a battery management circuit unit 500, described later, to manage each unit battery 100.

To the second connector 234, a sense line coming from a unit battery 100 housed on the first surface 210, and a sense line of tab potential of a unit battery 100 housed on the second surface 220 are connected. Therefore, it is preferred that the above second through-hole 233 be provided so as to pass through between the first surface 210 and the second surface 220.

Moreover, the second through-hole 233 offers space for an operation of connecting a sense line coming from a unit battery 100 to the second connector 234, and is therefore effective in terms of production efficiency.

In one end portion (or end portion on a side where the first battery housing chamber 215 and the fourth battery housing chamber 226 are disposed) of the unit battery housing body 200, and between the first through-hole 231 and the second through-hole 233, a grip through-hole 235 is so provided as to pass through between the first surface 210 and the second surface 220. The grip through-hole 235 and an adjacent area thereof function as a grip section 236. The grip section 236 contributes to making it easier to handle the battery module.

In the unit battery housing body 200, between the second battery housing chamber 216 of the first surface 210 and the third battery housing chamber 225 of the second surface 220, a bus-bar-laying through-hole 237 is so provided as to pass through between the first surface 210 and the second surface 220.

In the battery module of the present invention, batteries that are each disposed in the battery housing chambers are connected in series. The bus-bar-laying through-hole 237 makes it possible for one bus bar to stretch between the second battery housing chamber 216 of the first surface 210 and the third battery housing chamber 225 of the second surface 220. As a result, a unit battery 100 housed in the second battery housing chamber 216, and a unit battery 100 housed in the third battery housing chamber 225 are electrically connected together via the bus bar.

In one end portion (or end portion on a side where the first battery housing chamber 215 and the fourth battery housing chamber 226 are disposed) of the unit battery housing body 200, a fuse mounting through-hole 238 is so provided as to pass through between the first surface 210 and the second surface 220. A fuse is inserted in the middle of a power supply line of unit batteries 100 connected in series. The fuse mounting through-hole 238 is used to put the fuse. Near both longitudinal directions of the fuse mounting through-hole 238, two fuse-fixing screw holes 249 are disposed to allow a fuse, terminal, and bus bar to be fixed with screws. The fuse-fixing screw holes 249 are preferably provided in such a way that a metal cylindrical body, whose inner periphery is cut so as to form a screw pattern, is buried in and molded integrally with the unit battery housing body 200 made of resin.

In the unit battery housing body 200, cover-body locking through-holes 239 are provided at two locations so as to pass through between the first surface 210 and the second surface 220. In the unit battery housing body 200, as described later, unit batteries disposed on the first surface 210, and various wires are covered with a first surface cover body 310; unit batteries disposed on the second surface 220, and various wires are covered with a second surface cover body 320. When a cover body is mounted, a locking piece provided on the cover body engages with the above cover-body locking through-hole 239.

In the first battery housing chamber 215, the second battery housing chamber 216, the third battery housing chamber 225, and the fourth battery housing chamber 226, unit battery mounting sections 240 are erected on the front or back surface of the base in such a way as to be substantially in a cross shape.

The unit battery mounting sections 240 are provided at four locations in each housing chamber. The height of the unit battery mounting sections 240 from the front or back surface of the base is almost half the thickness of an electrode stack region 105 of a unit battery 100. Therefore, when unit batteries 100 are set in the housing chambers, the unit batteries 100 become stable.

In a central section of the cross shape of a unit battery mounting section 240, a unit battery alignment projection 241 of a pin-protruding shape is provided. When a unit battery 100 is set in a housing chamber, four unit battery alignment projections 241 are fitted into the alignment through-holes 111 that are provided at four locations of the laminate film outer casing in a peripheral portion of the unit battery 100. In this manner, when the unit battery 100 is mounted on the unit battery housing body 200, the unit battery 100 can be easily aligned, resulting in an improvement in productivity.

In the first battery housing chamber 215, the second battery housing chamber 216, the third battery housing chamber 225, and the fourth battery housing chamber 226, tab member mounting sections 245 are erected on the front or back surface of the base. The tab member mounting sections 245 are provided at two locations in each housing chamber.

The height of the tab member mounting sections 245 from the front or back surface of the base varies depending on the location. Therefore, a bus bar, described later, can be placed in a stable manner. More specifically, the height of a portion of a tab member mounting section 245 where a bus bar is placed is lower than a portion thereof where no bus bar is placed.

In one portion of a tab member mounting section 245, a tab member fixing screw hole 246 is provided. The tab member fixing screw holes 246 are preferably provided in such a way that a metal cylindrical body, whose inner periphery is cut so as to form a screw pattern, is buried in and molded integrally with the unit battery housing body 200 made of resin.

By using the tab member fixing screw holes 246, tabs of unit batteries 100, bus bars, and terminals of sense lines are integrally fixed with screws. Therefore, it is possible to: (1) mechanically fix the unit batteries 100 to the unit battery housing body 200; (2) electrically connect the tabs to the bus bars of the unit battery housing body 200; and (3) electrically connect the tabs and the sense lines.

In one pair of end portions, which face each other, on an outer periphery of the unit battery housing body 200, a first end side protruding guide member 250 and a second end side protruding guide member 255 are provided. The first end side protruding guide member 250 and the second end side protruding guide member 255 are so formed as to have a continuous convex portion extending in a longitudinal direction. The continuous convex portion is designed to slide in a concave section of a rack, which is described later. In this manner, the battery module of the present invention can be housed in the rack of the electric storage device.

In both end portions of the first end side protruding guide member 250, a tapered section 251 and a tapered section 252 are provided. In both end portions of the second end side protruding guide member 255, a tapered section 256 and a tapered section 257 are provided. Therefore, when the battery module is inserted into the concave sections of the rack as described above, it is easy to insert, making it easier to handle. When the battery module is taken out of the concave sections of the rack, each tapered section offers play. Therefore, there is less need to pay attention to the direction in which the battery module is removed, and it becomes easier to handle.

The width of the first end side protruding guide member 250 used is different from the width of the second end side protruding guide member 255 used. Therefore, it is possible to prevent the battery module that takes an unexpected posture from being inserted into or removed from the rack. Incidentally, the width of the first end side protruding guide member 250, or the width of the second end side protruding guide member 255, can be defined as a length seen in a direction perpendicular to the front or back surface of the base.

Both the first end side protruding guide member 250 and the second end side protruding guide member 255 are on side faces, which are different from the front and back surfaces of the base. On the two side faces that face each other, the first end side protruding guide member 250 and the second end side protruding guide member 255 are provided along a planar direction of the front or back surface of the base.

It can be said that the first end side protruding guide member 250 and the second end side protruding guide member 255 are so provided as to protrude from the peripheral partition wall sections (211, 221) or to extend from the base, and that, in each tapered section, a protruding amount of the above protruding, or an extending amount of the extending, varies.

The unit battery housing body 200 adopts a structure in which unit batteries 100 disposed on the first surface 210, and various wires are covered with the first surface cover body 310, and unit batteries 100 disposed on the second surface 220, and various wires are covered with the second surface cover body 320. Therefore, nine cover body fixing screw holes 260, which are used to fix the first surface cover body 310 to the first face 210 with screws, are provided on the first surface 210. Similarly, nine cover body fixing screw holes 260, which are used to fix the second surface cover body 320 to the first face 220 with screws, are provided on the second surface 220. On each surface, nine cover body fixing screw holes 260 are provided. However, all the cover body fixing screw holes 260 may not be used for screw-fixing. Moreover, the number of cover body fixing screw holes 260 provided on one surface is not limited to nine; any number of cover body fixing screw holes 260 can be provided. As illustrated in the diagrams, as for the positions where the cover body fixing screw holes 260 are placed, those on the first surface 210 are so disposed as to be symmetrical to and adjacent to those on the second surface 220. Accordingly, compared with the case where the cover body fixing screw holes 260 are placed at the same positions, it is possible to reduce the thickness required for the screw holes, thereby easily making the battery module thinner.

The following describes a process of mounting unit batteries 100 and other components in the unit battery housing body 200 having the above configuration to make the battery module of the present invention.

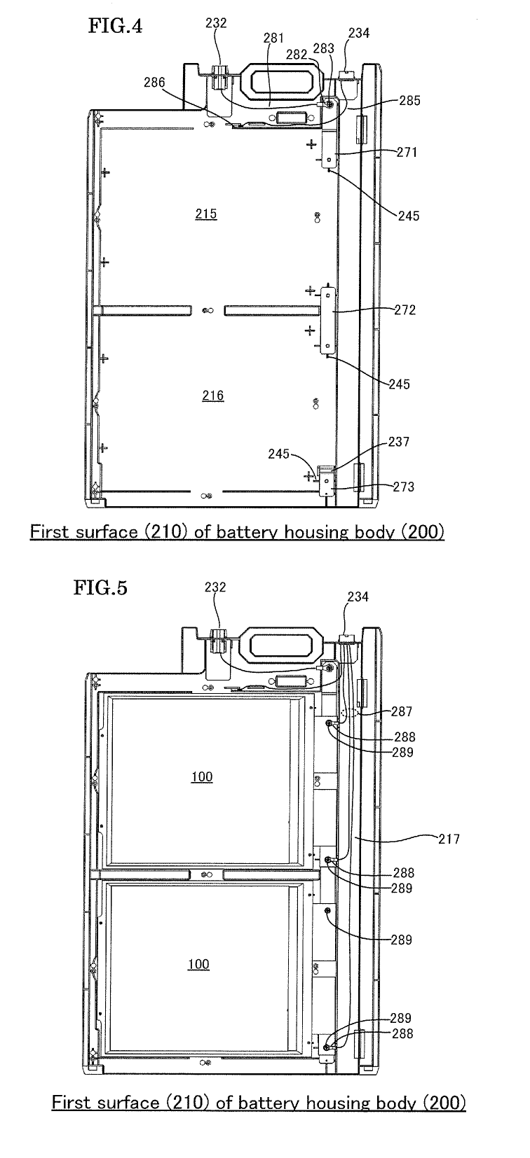

First, with reference to FIGS. 4 and 5, a process of mounting on the first surface 210 of the unit battery housing body 200 will be described.

On a tab member mounting section 245 that is provided between a compartment where the first connector 232 and the second connector 234 are provided and a compartment of the first battery housing chamber 215, a first bus bar 271 is placed. On the first bus bar 271, two through-holes are provided at locations that face the tab member fixing screw holes 246 when being placed on the tab member mounting section 245.

In a hole of a power supply line terminal 282 of a power supply line 281, and in a through-hole (or through-hole on the first connector's side) of the first bus bar 271, and in a tab member fixing screw hole 246, a screw 283 is inserted. Then, the power supply line terminal 282, the first bus bar 271, and the tab member fixing screw hole 246 are integrally fastened with the screw 283. In this manner, the components are mechanically fixed and electrically connected.

An end portion of the power supply line 281 where no power supply line terminal 282 is provided is electrically connected to a terminal, not shown, that is enclosed in a casing of the first connector 232.

In a space formed by the first surface compartmentalization partition wall sections 212, a thermistor 286 is disposed. A thermistor connection line 285 of the thermistor 286 is electrically connected to a terminal, not shown, of the second connector 234.

The thermistor 286 detects a temperature inside the battery module; a detection signal thereof is transmitted to the battery management circuit unit 500 via the second connector 234. In the battery module of the present invention, the battery management circuit unit 500 obtains temperature data from the thermistor 286, and carries out control processes, such as discharge stop, based on the data.

Then, on a tab member mounting section 245 that is provided between a compartment of the first battery housing chamber 215 and a compartment of the second battery housing chamber 216, a second bus bar 272 is placed. On the first bus bar 272, two through-holes are provided at locations that face the tab member fixing screw holes 246 when being placed on the tab member mounting section 245.

Then, on a tab member mounting section 245 that is provided in the second battery housing chamber 216 on the first surface 210, and on a tab member mounting section 245 that is provided in the third battery housing chamber 225 on the second surface 220, a third bus bar 273 is mounted. The cross section of the third bus bar 273 is substantially in a Z-shape. Through the bus-bar-laying through hole 237, the third bus bar 273 is so mounted as to stretch between the first surface 210 and the second surface 220. On the third bus bar 273, two through-holes are provided at locations that face the tab member fixing screw holes 246 when being placed at a predetermined position.

Then, as shown in FIG. 5, in the first battery housing chamber 215 and the second battery housing chamber 216, unit batteries 100 are respectively placed. In this process, the unit battery alignment projections 241 of the unit battery housing body 200 are inserted into the alignment through-holes 111 of the unit batteries 100. Therefore, the unit batteries 100 easily can be placed on the unit battery housing body 200.

Incidentally, when the unit batteries 100 are placed in the housing chambers, two-sided tap 150 is utilized, and is affixed to the housing chambers when the unit batteries 100 are fixed.

Then, as shown in FIG. 5, in a hole of a sense line terminal 288 of a sense line 287, and in a hole (a through-hole 135 of a negative electrode pulled-out tab 130, or a through-hole 145 of an additional tab member 140) of a tab member, and in a through-hole of a bus bar, and in a tab member fixing screw hole 246, a screw 289 is inserted. Then, the sense line terminal 288, the bus bar, the tab member, and the tab member fixing screw hole 246 are integrally fastened with the screw 289. In this manner, the components are mechanically fixed and electrically connected.

An end portion of the sense line 287 where no sense line terminal 288 is provided is electrically connected to a terminal, not shown, of the second connector 234. Potential of the tab that is detected at the sense line terminal 288 is transmitted to the battery management circuit unit 500 via the second connector 234. The battery management circuit unit 500 obtains potential data from each tab, and carries out control processes, such as discharge stop, based on the data.

In order to lay the sense line 287 between the sense line terminal 288 and the second connector 234, the first surface wiring housing chamber 217 is used.

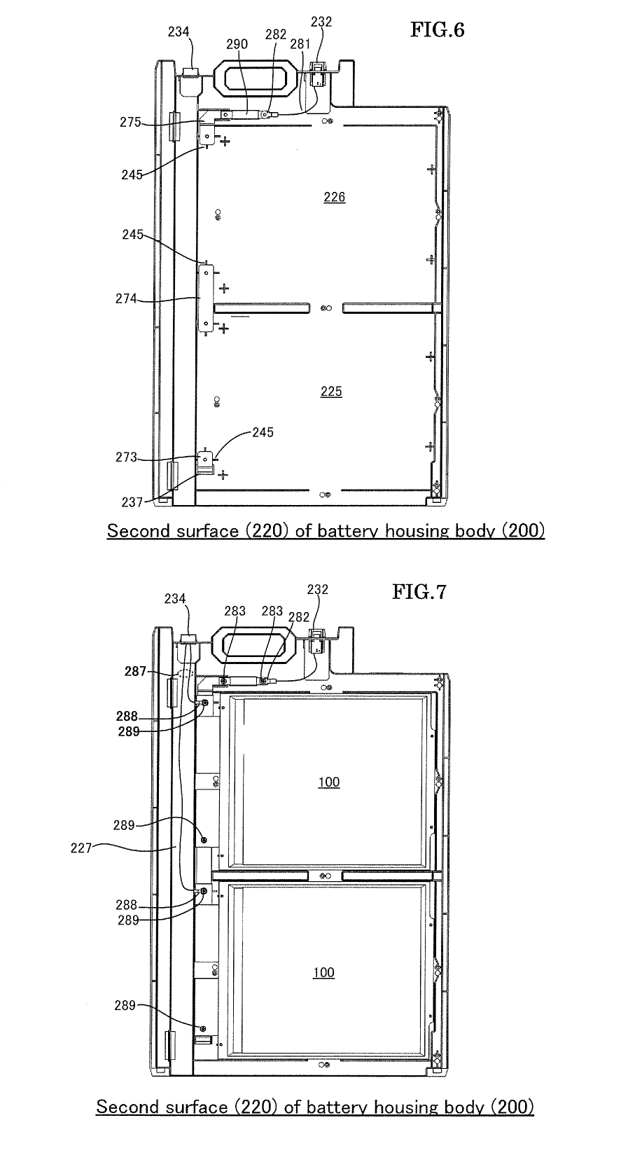

With reference to FIGS. 6 and 7, a process of mounting various components on the second surface 220 of the unit battery housing body 200 will be described.

First, on a tab member mounting section 245 that is provided between a compartment of the third battery housing chamber 255 and a compartment of the fourth battery housing chamber 226, a fourth bus bar 274 is placed. On the fourth bus bar 274, two through-holes are provided at locations that face the tab member fixing screw holes 246 when being placed on the tab member mounting section 245.

On a tab member mounting section 245 that is provided between a compartment of the fourth battery housing chamber 226 and a compartment where the first connector 232 and the second connector 234 are provided, a fifth bus bar 275 is provided. On the fifth bus bar 275, two through-holes are provided: One through-hole is placed so as to face a tab member fixing screw hole 246 on the tab member mounting section 245, and the other is so placed as to face a fuse-fixing screw hole 249.

Then, in a fuse mounting through-hole 238, a fuse 290 is placed. In one terminal hole of the fuse 290, in a through-hole of the fifth bus bar 275, and in a fuse-fixing screw hole 249, a screw 283 is inserted. The fuse 290, the fifth busbus bar bar 275, and the tab member fixing screw hole 246 are integrally fastened with the screw 283. In this manner, the components are mechanically fixed and electrically connected.

In the other terminal hole of the fuse 290, in a power line terminal 282 of a power supply line 281, and in a fuse-fixing screw hole 249, a screw 283 is inserted. The fuse 290, the power line terminal 282, and the fuse-fixing screw hole 249 are integrally fastened with the screw 283. In this manner, the components are mechanically fixed and electrically connected.

An end portion of the power supply line 281 where no power line terminal 282 is provided is electrically connected to a terminal, not shown, of the first connector 232.

Then, as shown in FIG. 7, in the third battery housing chamber 225 and the fourth battery housing chamber 226, unit batteries 100 are respectively placed. In this process, the unit battery alignment projections 241 of the unit battery housing body 200 are inserted into the alignment through-holes 111 of the unit batteries 100. Therefore, the unit batteries 100 easily can be placed on the unit battery housing body 200.

Incidentally, when the unit batteries 100 are placed in the housing chambers, two-sided tap 150 is utilized, and is affixed to the housing chambers when the unit batteries 100 are fixed.

Then, as shown in FIG. 7, in a hole of a sense line terminal 288 of a sense line 287, and in a hole (a through-hole 135 of a negative electrode pulled-out tab 130, or a through-hole 145 of an additional tab member 140) of a tab member, and in a through-hole of a bus bar, and in a tab member fixing screw hole 246, a screw 289 is inserted. Then, the sense line terminal 288, the bus bar, the tab member, and the tab member fixing screw hole 246 are integrally fastened with the screw 289. In this manner, the components are mechanically fixed and electrically connected.

An end portion of the sense line 287 where no sense line terminal 288 is provided is electrically connected to a terminal, not shown, of the second connector 234. Potential of the tab that is detected at the sense line terminal 288 is transmitted to the battery management circuit unit 500 via the second connector 234. The battery management circuit unit 500 obtains potential data from each tab, and carries out control processes, such as discharge stop, based on the data.

In order to lay the sense line 287 between the sense line terminal 288 and the second connector 234, the second surface wiring housing chamber 227 is used.

As described above, various components are mounted on the unit battery housing body 200. Voltage from the four unit batteries 100 connected in series can be taken out through the first connector 232. The potential of the tab of each unit battery 100, and the temperature detected by the thermistor can be taken out through the second connector 234.

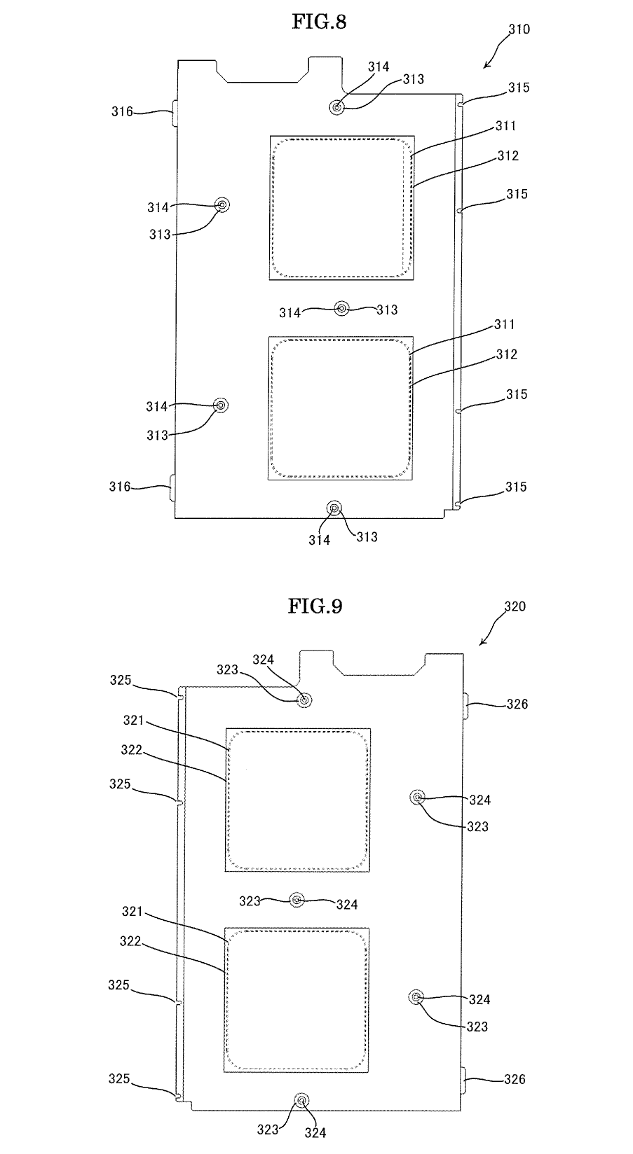

The following describes cover bodies that cover the unit battery housing body 200 on which various components are mounted as described above. FIG. 8 is a diagram illustrating the first surface cover body 310 that is used in making the battery module according to the embodiment of the present invention. FIG. 9 is a diagram illustrating the second surface cover body 320. The first surface cover body 310 and the second surface cover body 320 have the same configuration except that the first surface cover body 310 is mirror-symmetrical to the second surface cover body 320. Therefore, the first surface cover body 310 will be illustrated below.

The first surface cover body 310 is a cover member made of aluminum to cover a unit battery 100, power supply line 281, sense line 287, thermistor 286, and other components that are housed on the first surface 210 of the unit battery housing body 200.

Raising of the first surface cover body 310 (battery-pressing raised sections 311) has been performed to press the unit battery 100 housed in the first battery housing chamber 215 and the unit battery 100 housed in the second battery housing chamber 216 when the first surface cover body 310 is mounted on the first surface 210. Because of the battery-pressing raised sections 311, the surfaces that press the unit batteries 100 are defined as pressing surfaces 312. The pressing surfaces 312 that are based on the battery-pressing raised sections 311 press electrode stack regions 105 of the unit batteries 100 when the first surface cover body 310 is mounted, thereby suppressing bulging of unit batteries 100 and the like, which might occur over time as the unit batteries 100 are used, and extending the life of the unit batteries 100.

Incidentally, the battery-pressing raised sections 311 are formed in a direction in which the battery-pressing raised sections 311 protrude from the paper surface of FIG. 8. Dotted lines indicate how the back surface of the first surface cover body 310 is formed.

On the first surface cover body 310, screw holes 314 and notch sections 315 are formed at locations that face the cover body fixing screw holes 260 when the first surface cover body 310 is mounted on the first surface 210. Around the screw holes 314, screw-hole raised sections 313 are provided. Therefore, the first surface cover body 310 is fixed in such a way that regions of the first surface cover body 310 around the screw holes 314 come in close contact with the first surface 210. Incidentally, the screw-hole raised sections 313 are formed in a direction in which the screw-hole raised sections 313 protrude from the paper surface of FIG. 8.

On one side of the first surface cover body 310, locking pieces 316 are provided; the locking pieces 316 engage with two cover-body locking through-holes 239 provided on the unit battery housing body 200.

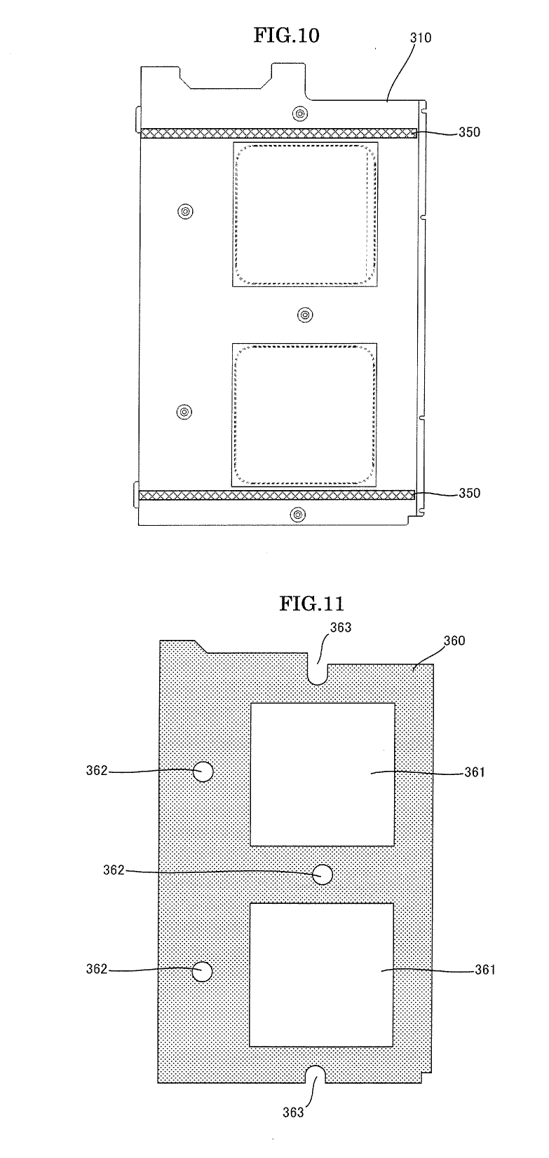

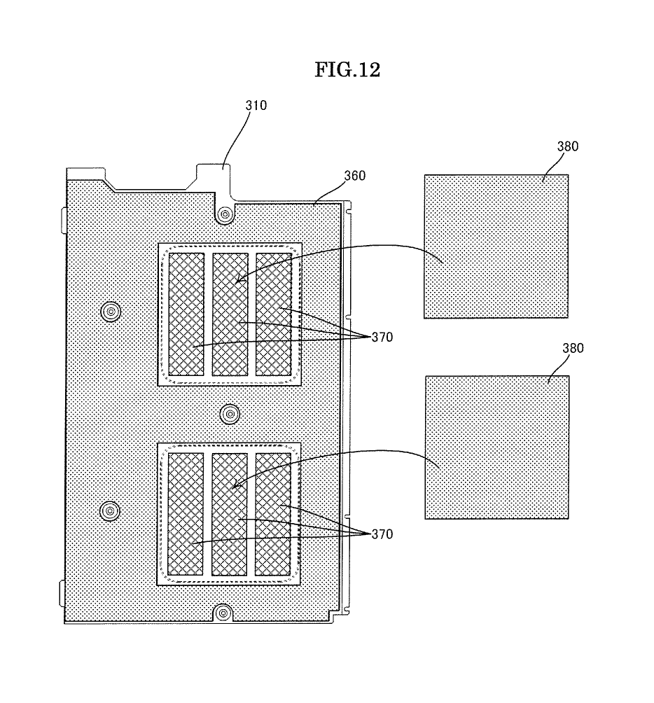

Then, a process of giving insulation properties to the above first surface cover body 310 to protect the unit batteries 100 and wires housed in the unit battery housing body 200 will be described. First, as shown in FIG. 10, to the first surface cover body 310, two strips of two-sided tape 350 are affixed.

Then, with the two strips of two-sided tape 350, a cover body insulation sheet 360 shown in FIG. 11 is affixed to the first surface cover body 310. On the cover body insulation sheet 360, the following are provided: pressing-surface punched sections 361, which correspond to the pressing surfaces 312 of the first surface cover body 310; screw-hole punched sections 362, which correspond to the screw holes 314 of the first surface cover body 310; and screw-hole notch sections 363, which correspond to the notch sections 315 of the first surface cover body 310.

To the two pressing surfaces 312 of the first surface cover body 310, three strips of two-sided tape 370 are affixed. With the three strips of two-sided tape 370, a pressing-surface insulation sheet 380 is affixed to each pressing surface 312.

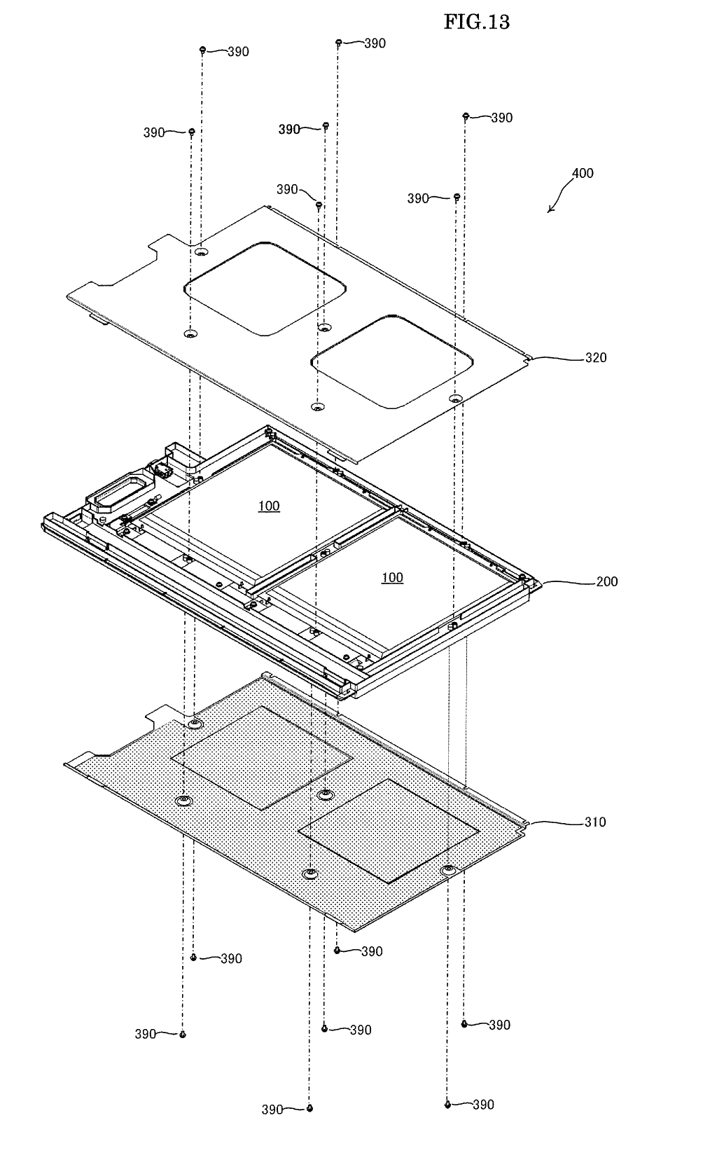

Then, as shown in FIG. 13, the first surface cover body 310 and the second surface cover body 320, to which insulation sheets are affixed, are mounted in such a way that the unit battery housing body 200 is sandwiched between the first surface cover body 310 and the second surface cover body 320. When the first surface cover body 310 and the second surface cover body 320 are mounted on the unit battery housing body 200, the locking pieces 316 and 326 of both the bodies engage with the cover-body locking through-holes 239.

Incidentally, when the unit battery housing body 200 is held between the first surface cover body 310 and the second surface cover body 320, the two-sided tape 150 provided on the unit batteries 100 is used to affix the pressing-surface insulation sheets 380 to the unit batteries 100.

From the first surface cover body 310's side, with seven screws 390, the first surface cover body 310 and the cover body fixing screw holes 260 of the unit battery housing body 200 are fastened. Similarly, from the second surface cover body 320's side, with seven screws 390, the second surface cover body 320 and the cover body fixing screw holes 260 of the unit battery housing body 200 are fastened.

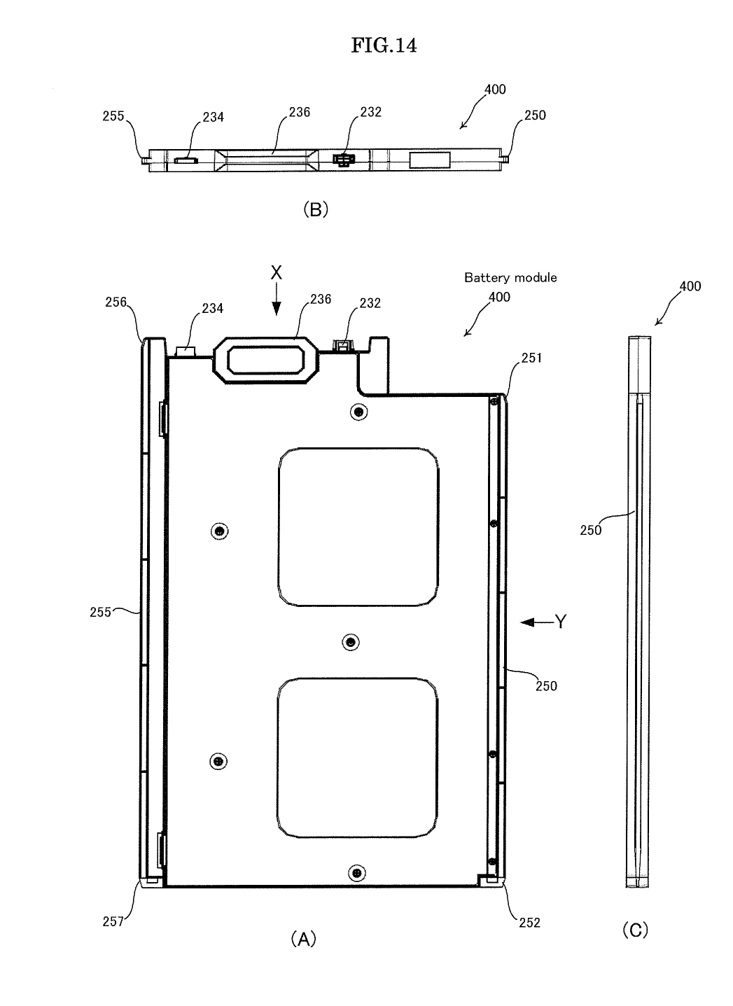

FIG. 14 is a diagram showing a battery module 400 according to the embodiment of the present invention, which is produced by the above processes. FIG. 14(A) is a view of a main surface of the battery module 400. FIG. 14(B) is a view of the battery module 400 when seen from a direction of X of FIG. 14(A). FIG. 14(C) is a view of the battery module 400 when seen from a direction of Y of FIG. 14(A).

As for the appearance of the battery module 400, the first connector 232, from which power supply of the batteries are taken out, and the second connector 234, from which monitored data such as the tab potential of the batteries and temperatures are taken out, are exposed.

In one pair of end portions, which face each other, of the battery module 400, a first end side protruding guide member 250 and a second end side protruding guide member 255 are disposed: in both end portions of each member, tapered portions are provided. The protruding guide members are used when the battery module 400 is mounted on a rack of an electric storage device as described later.

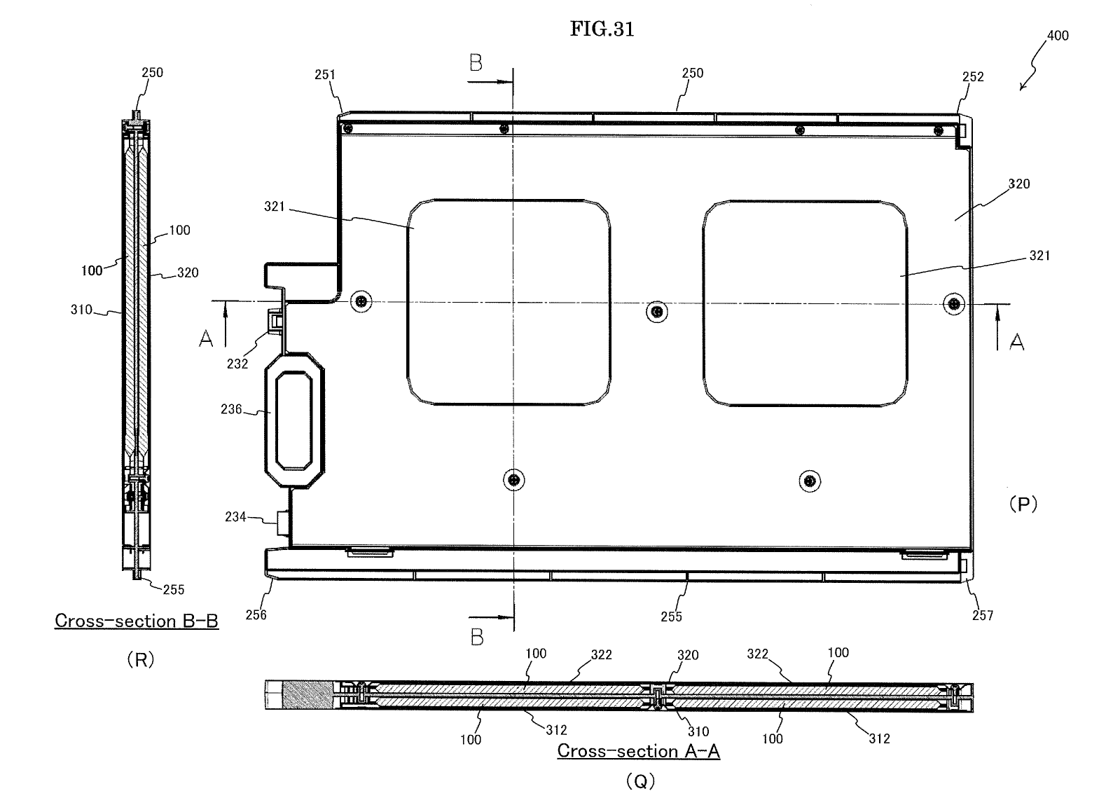

FIG. 31 is a cross-sectional view of the battery module 400 according to the embodiment of the present invention. In FIG. 31, FIG. 31(Q) is a view of an A-A cross section of FIG. 31(P); FIG. 31(R) is a view of a B-B cross section of FIG. 31(P).

In the above battery module 400 of the present invention, the peripheral partition wall sections (211, 221) keep the rigidity of the battery module 400 high. Therefore, it is possible to provide the battery module 400 that easily can be made thinner and maintain reliability.

Moreover, the compartmentalization partition wall sections (212, 222), which are provided between the adjacent unit batteries 100 within a surface, keep troubles of one battery such as abnormal heating from affecting the other battery. Therefore, it is possible to provide the battery module that can easily ensure a high level of flame retardancy. Moreover, the compartmentalization partition wall sections (212, 222, 218, 228) provided on both surfaces of battery mounting planes help to keep the rigidity of the battery module 400 high. Therefore, it is possible to provide the battery module 400 that easily can be made thinner and maintain reliability.

Moreover, by the cover bodies (310, 320) that press the unit batteries 100 in a sheet thickness direction, deformation of the unit batteries 100 can be effectively suppressed. Therefore, it is possible to provide the battery module 400 that easily can maintain excellent battery characteristics such as repeated charge-and-discharge performance. In addition, the peripheral rib sections provided on both sides of the battery mounting plane, and the compartmentalization partition wall sections help to keep the rigidity of the battery module high. Therefore, it is possible to provide the battery module that easily can be made thinner and maintain reliability.

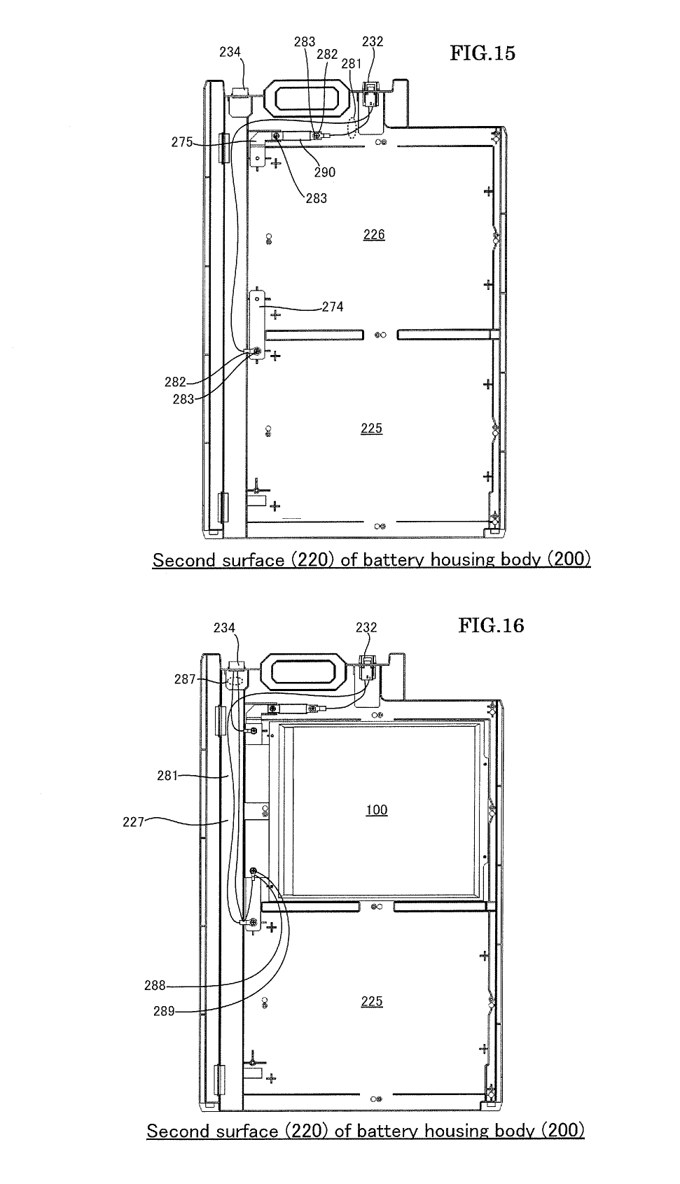

The following describes a case where all the housing chambers of the unit battery housing body 200 are not used for mounting the unit batteries 100, with reference to FIGS. 15 to 17.

In the battery module 400 described above, the unit batteries 100 are housed in all the four housing chambers of the unit battery housing body 200, and are connected in series; through the first connector 232, the voltage four times larger than a unit battery 100 is taken out.

However, in a charging device that uses the voltage of the battery modules 400 connected in series, the voltage that is a multiple of four times that of the unit battery 100 is not always used. Accordingly, for example, what is prepared is one in which only one unit battery 100 is mounted in the battery module 400 so that the voltage that is one times that of the unit battery 100 is taken out; it is therefore possible to support various charging devices.

The following describes a battery module 400 in which a unit battery 100 is mounted in only one housing chamber of the unit battery housing body 200 so that the same voltage as that of the unit battery 100 is taken out, with reference to FIGS. 15 to 17. Hereinafter, the unit battery housing body 200 and unit battery 100 used are the same as those described above, and therefore will not be described again.

FIGS. 15 and 16 are diagrams illustrating a process of mounting various components of the battery module 400 from which the same voltage as that of the above unit battery 100 is taken out. In the battery module 400, a unit battery 100 is housed in the fourth battery housing chamber 226 on the second surface 220 to form the battery module 400.

First, on a tab member mounting section 245 that is provided between a compartment of the fourth battery housing chamber 226 and a compartment in which the first connector 232 and the second connector 234 are provided, a fifth bus bar 275 is placed. On the fifth bus bar 275, two through-holes are provided: One through-hole is provided at a location that faces the tab member fixing screw hole 246 on the tab member mounting section 245, and the other through-hole is provided at a location that faces the fuse-fixing screw hole 249.

Then, in the fuse mounting through-hole 238, the fuse 290 is placed. In one terminal hole of the fuse 290, in the through-hole of the fifth bus bar 275, and in the fuse-fixing screw hole 249, a screw 283 is inserted. The fuse 290, the fifth bas bar 275, and the tab member fixing screw hole 246 are integrally fastened with the screw 283. In this manner, the components are mechanically fixed and electrically connected.

In the other terminal hole of the fuse 290, in the power line terminal 282 of the power supply line 281, and in the fuse-fixing screw hole 249, a screw 283 is inserted. The fuse 290, the power line terminal 282, and the fuse-fixing screw hole 249 are integrally fastened with the screw 283. In this manner, the components are mechanically fixed and electrically connected.

An end portion of the power supply line 281 where no power line terminal 282 is provided is electrically connected to a terminal, not shown, of the first connector 232.

Then, on a tab member mounting section 245 that is provided between a compartment of the third battery housing chamber 255 and a compartment of the fourth battery housing chamber 226, a fourth bus bar 274 is placed. On the fourth bus bar 274, two through-holes are provided at locations that face the tab member fixing screw holes 246 when being placed on the tab member mounting section 245.

As shown in FIG. 15, in a hole of the power line terminal 282 of the power supply line 281, in a through-hole of the fourth bus bar 274, and in the tab member fixing screw hole 246, a screw 283 is inserted. Then, the power line terminal 282, the fourth bus bar 274, and the tab member fixing screw hole 246 are integrally fastened with the screw 283. In this manner, the components are mechanically fixed and electrically connected. An end portion of the power supply line 281 where no power line terminal 282 is provided is electrically connected to a terminal, not shown, of the first connector 232. In order to lay the power supply line 281, the second surface wiring housing chamber 227 is used.

Then, as shown in FIG. 16, only in the fourth battery housing chamber 226, a unit battery 100 is placed. In this process, the unit battery alignment projections 241 of the unit battery housing body 200 are inserted into the alignment through-holes 111 of the unit battery 100. Therefore, the unit battery 100 easily can be placed on the unit battery housing body 200.

Incidentally, when the unit battery 100 is placed in the housing chamber, two-sided tap 150 is utilized, and is affixed to the housing chamber when the unit battery 100 is fixed.

Then, as shown in FIG. 16, in a hole of the sense line terminal 288 of the sense line 287, and in a hole (the through-hole 135 of the negative electrode pulled-out tab 130) of a tab member, and in the through-hole of the fourth bus bar 274, and in the tab member fixing screw hole 246, a screw 289 is inserted. Then, the sense line terminal 288, the fourth bus bar 274, the tab member, and the tab member fixing screw hole 246 are integrally fastened with the screw 289. In this manner, the components are mechanically fixed and electrically connected.

An end portion of the sense line 287 where no sense line terminal 288 is provided is electrically connected to a terminal, not shown, of the second connector 234. Potential of the tab that is detected at the sense line terminal 288 is transmitted to the battery management circuit unit 500 via the second connector 234. The battery management circuit unit 500 obtains potential data from each tab, and carries out control processes, such as discharge stop, based on the data.

In order to lay the sense line 287 between the sense line terminal 288 and the second connector 234, the second surface wiring housing chamber 227 is used.

In that manner, various components are mounted on the unit battery housing body 200. As a result, the same voltage as that of one unit battery 100 can be take out through the first connector 232. The potential of the tab of one unit battery 100 mounted, and the temperature detected by the thermistor can be taken out through the second connector 234.

When cover bodies are provided on the above unit battery housing body 200, the first surface 210 is blank because no unit batteries 100 are placed. Therefore, as for the first surface cover body 310 that is provided on the first surface 210, the cover body insulation sheet 360 can be omitted.

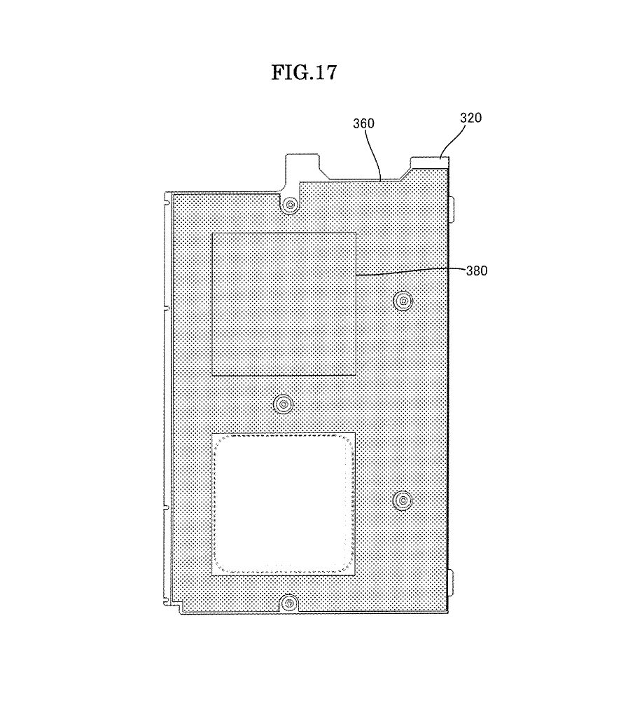

On the first surface 210, because the unit battery 100 is mounted only in the fourth battery housing chamber 226, and the third battery housing chamber 225 is blank, it is possible to use a second surface cover body 320 to which the cover body insulation sheet 360 and only one pressing-surface insulation sheet 380 are affixed as shown in FIG. 17.

The above unit battery housing body 200 and cover bodies are used in a similar way to that in FIG. 13 to cover the unit battery housing body 200. In this manner, it is possible to form the battery module 400 from which the same voltage as that of the unit battery 100 is taken out.

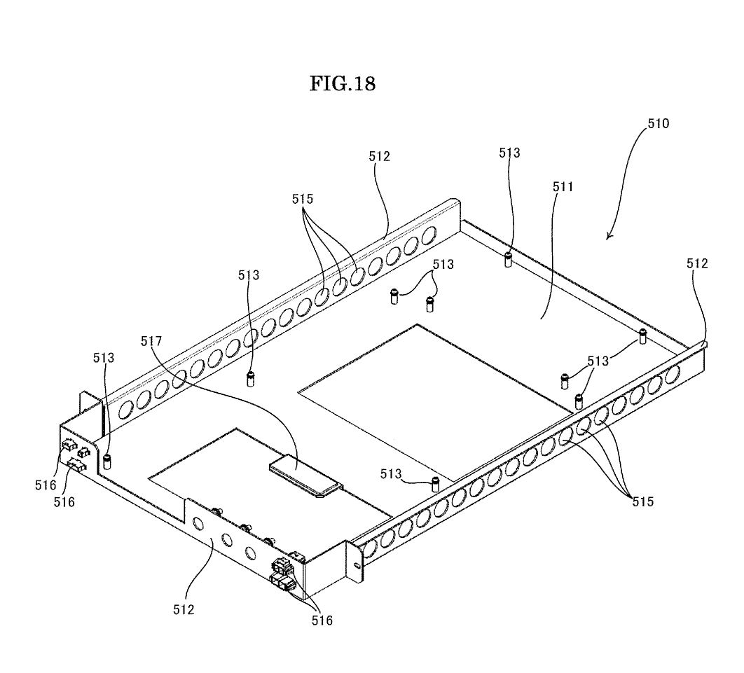

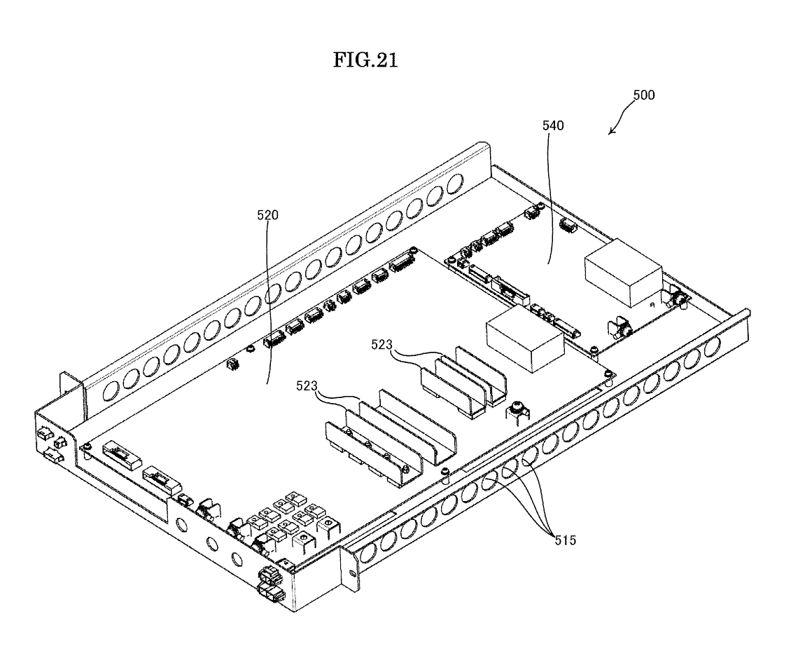

The following provides an outline of the configuration of the battery management circuit unit 500 that manages the above battery module 400 according to the present invention. FIGS. 18, 19, and 20 are diagrams illustrating a production process of the battery management circuit unit 500. FIG. 21 is a diagram showing the battery management circuit unit 500.

In FIG. 18, a chassis 510 on which the boards and connectors that constitute the battery management circuit unit 500 are mounted includes a bottom surface section 511, and side wall sections 512, which are so provided as to extend vertically from the bottom surface section 511. On the bottom surface section 511, a plurality of screw hole sections 513 are erected vertically from the bottom surface section 511.

On two side wall sections 512, which face each other, of the chassis 510, a plurality of ventilation holes 515 are provided along a longitudinal direction of the side wall sections 512. Between the two side wall sections 512 facing each other, the ventilation holes 515 makes it easier for a steam of air to flow easily.

On the side wall sections 512 of the chassis 510, connectors 516 are mounted to be electrically connected to the battery module 400. On the bottom surface section 511, a heat dissipation sheet 517 is mounted to release heat generated from the boards.

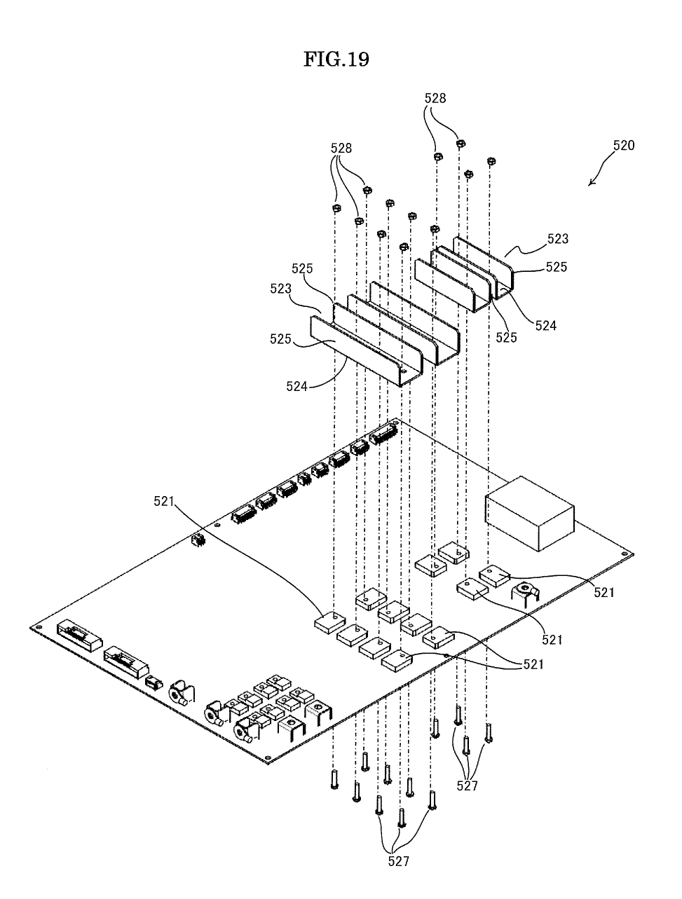

FIG. 19 shows a production process of a first circuit board 520. On the first circuit board 520, semiconductor components 521, such as FETs, which generate heat when in use, are mounted. On the semiconductor components 521, a heat sink 523 is mounted with bolts 527 and nuts 528 as shown in the diagram: the heat sink 523 includes a bottom surface section 524, and fins 525, which are so provided as to extend vertically therefrom.

Incidentally, according to the present embodiment, when the heat sink 523 is mounted on the semiconductor components 521, fixing means, such as bolts 527 and nuts 528, are used. Instead, when the heat sink 523 is mounted on the semiconductor components 521, both may be bonded together with an adhesive; or, when the heat sink 523 is mounted on the semiconductor components 521, the bolts 527 and nuts 528 and the adhesive may be used together.

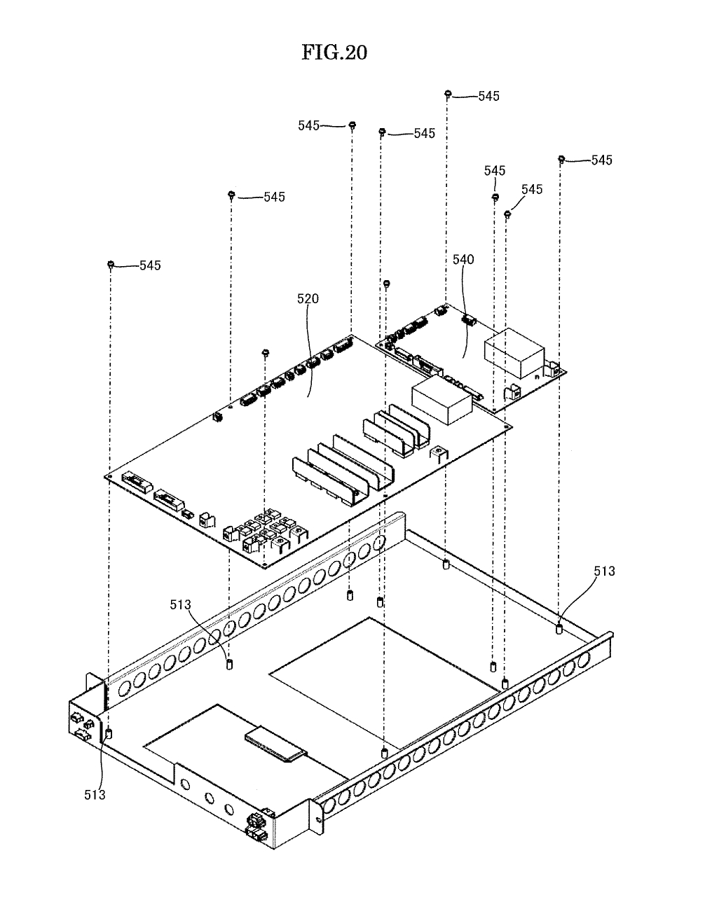

FIG. 20 shows a process of fixing the first circuit board 520 and a second circuit board 540 to the chassis 510 with screws 545 by using screw hole sections 513. FIG. 21 shows the battery management circuit unit 500 completed.

As shown in FIG. 21, a direction perpendicular to the two side wall sections 512 which face each other and on which the ventilation holes 515 are provided is parallel to a longitudinal direction of the fins 525 of the heat sinks 523. Therefore, the stream of air going into, or coming out of, the ventilation holes 515 helps to cool the fins 525 of the heat sinks 523 in an efficient manner, making it possible to improve the efficiency of the semiconductor components 521.

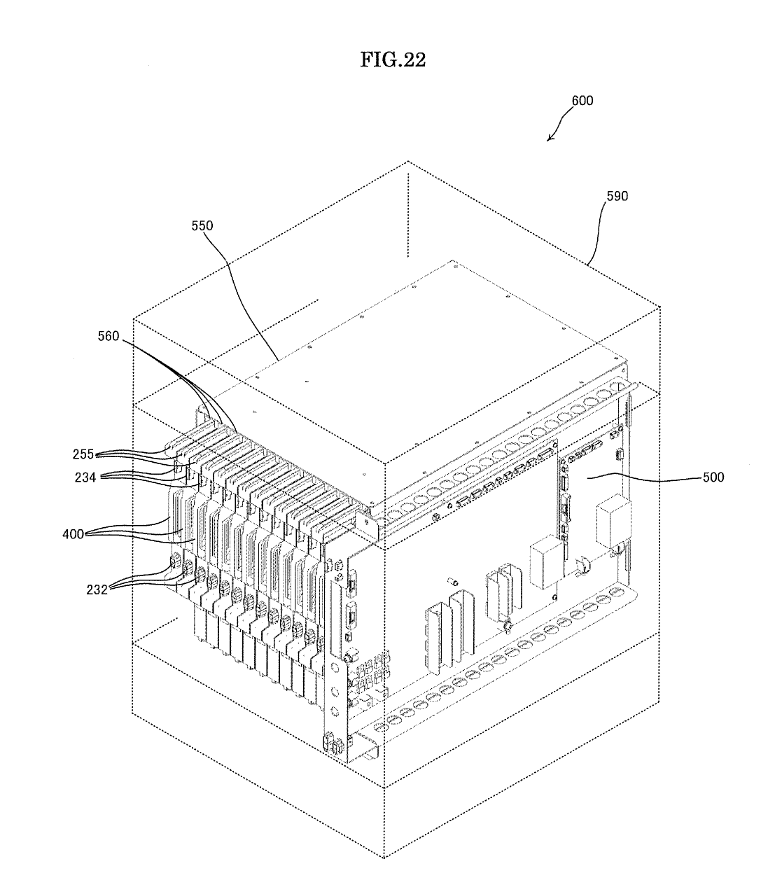

The battery module 400 and battery management circuit unit 500 that are configured as described above are used to make an electric storage device 600. FIG. 22 is a diagram outlining the electric storage device 600 that uses the battery modules 400 according to an embodiment of the present invention.

In a housing 590 of the electric storage device 600, the following are housed: a module housing rack 550, which houses a plurality of battery modules 400; and the battery management circuit unit 500, which is mounted integrally with the module housing rack 550. Furthermore, in the spaces of the housing 590 that are above and below the above components, a power conditioner, and an air blowing unit, which is used to cool the battery management circuit unit 500, are provided; however, these components are not shown in FIG. 22.

Above and below the module housing rack 550, thirteen pairs of concave guide members 560 are provided. For one pair of upper and lower concave guide members 560, one battery module 400 is fitted into a first end side protruding guide member 250 (lower) and a second end side protruding guide member 255 (upper), which are provided above and below the battery module 400; the battery module 400 can be inserted and removed.

Incidentally, the width of the first end side protruding guide member 250 is different from the width of the second end side protruding guide member 255. The concave portions of the upper and lower concave guide members 560 of the module housing rack 550 are similarly different in width. If the battery module 400 is placed upside down, the battery module 400 cannot be inserted into the module housing rack 550. Therefore, it is possible to prevent the battery module 400 from being misused.

As for thirteen battery modules 400 that are housed in the module housing rack 550, the first connectors 232 of the adjacent battery modules 400 are connected together in series via wire harnesses, not shown. Therefore, the battery modules 400 are input to the battery management circuit unit 500.

In an embodiment shown in FIG. 22, twelve battery modules 400 each of which houses four unit batteries 100 connected in series, and one battery module 400 which houses one unit battery 100, i.e. thirteen battery modules 400 in total, are mounted in the module housing rack 550. Based on a total sum of all the battery modules 400, voltage that is 49 times larger than that of the unit battery 100 can be taken out.

Meanwhile, the second connectors 234 of the thirteen battery modules 400 each are independently connected to the battery management circuit unit 500. The battery management circuit unit 500 therefore obtains potential data of each unit battery 100 and temperature data of the inside of each battery module 400, and carries out control processes, such as discharge stop, based on the data.

Another embodiment of the present invention will be described. According to another embodiment, the configuration of a battery housed in one battery housing chamber of the battery module 400 is different from the above embodiment, which will be described below.

According to the above embodiment, one unit battery 100 is housed in one battery housing chamber of the battery module 400. According to the present embodiment, an assembled battery in which a plurality of unit batteries 100 are connected together in parallel is housed in one battery housing chamber of the battery module 400.

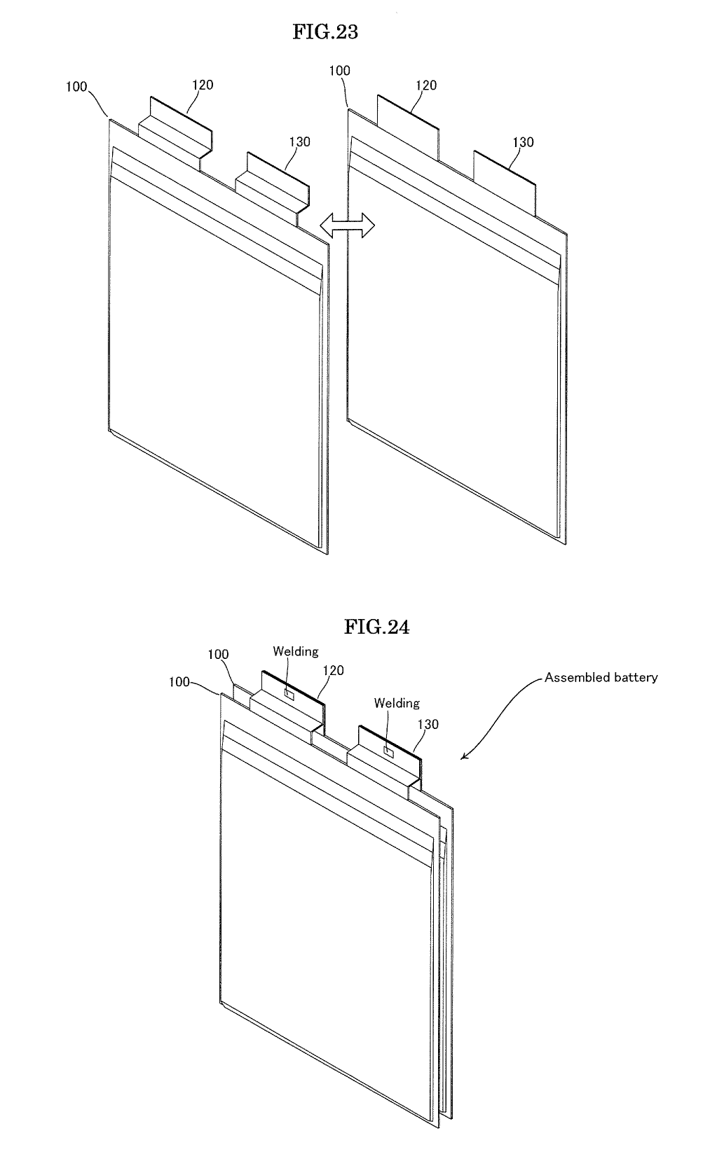

The structure will be described below in detail. FIG. 23 is a diagram illustrating an assembled battery that includes unit batteries 100 connected in parallel for making a battery module 400 according to another embodiment of the present invention. In an example of FIG. 23, two unit batteries 100 are connected in parallel to form one assembled battery. Instead, three or more unit batteries 100 may be connected in parallel to form one assembled battery.

In an embodiment shown in FIG. 23, a positive electrode pulled-out tab 120 and negative electrode pulled-out tab 130 of one unit battery 100 are bent and are joined to a positive electrode pulled-out tab 120 and negative electrode pulled-out tab 130 of the other unit battery 100 that are not bent. In this case, the same-polarity pulled-out tabs of the two unit batteries 100 are, for example, welded together as shown in FIG. 24. As a result, what is obtained is an assembled battery in which the unit batteries 100 are connected in parallel as shown in FIG. 24.

According to the present embodiment, the above assembled batteries are housed in the first battery housing chamber 215, second battery housing chamber 216, third battery housing chamber 225, and fourth battery housing chamber 226 of the unit battery housing body 200, and are connected in series as in the case of the above embodiment.

According to the present embodiment, compared with the one in which one battery housing chamber houses one unit battery 100, a larger capacity battery module 400 can be made.

As described above, in the battery module of the present invention, the peripheral partition wall sections help keep the rigidity of the battery module high. Therefore, it is possible to provide a battery module that easily can be made thinner and maintain reliability.

Moreover, the compartmentalization partition wall sections, which are provided between the adjacent unit batteries within a surface, keep troubles of one battery such as abnormal heating from affecting the other battery. Therefore, it is possible to provide the battery module that can easily ensure a high level of flame retardancy. Moreover, the compartmentalization partition wall sections provided on both surfaces of battery mounting planes help to keep the rigidity of the battery module high. Therefore, it is possible to provide the battery module that easily can be made thinner and maintain reliability.

Moreover, by the cover bodies that press the unit batteries in a sheet thickness direction, deformation of the battery elements can be effectively suppressed. Therefore, it is possible to provide the battery module that easily can maintain excellent battery characteristics such as repeated charge-and-discharge performance. In addition, the peripheral rib sections provided on both sides of the battery mounting plane, and the compartmentalization partition wall sections help to keep the rigidity of the battery module high. Therefore, it is possible to provide the battery module that easily can be made thinner and maintain reliability.

The following describes a second embodiment of the present invention with reference to the drawings.

The above-described battery module 400 of the first embodiment of the present invention houses a unit battery 100 with a positive electrode pulled-out tab 120 and negative electrode pulled-out tab 130 pulled out of one end portion of the unit battery 100, i.e. a unit battery with one-side tabs. Two unit batteries 100 are housed on one side of a battery module 400, or four unit batteries 100 on both sides. The inserting of the battery module 400 into the module housing rack 550 and the removing of the battery module 400 from the module housing rack 550 are realized by fitting the protruding guide members (250, 255), one of which is provided in the upper portion of the battery module 400 and the other one in the lower portion thereof, into the concave guide members 560 of the module housing rack 550.

However, the battery modules of the present invention are not limited to the above configuration.

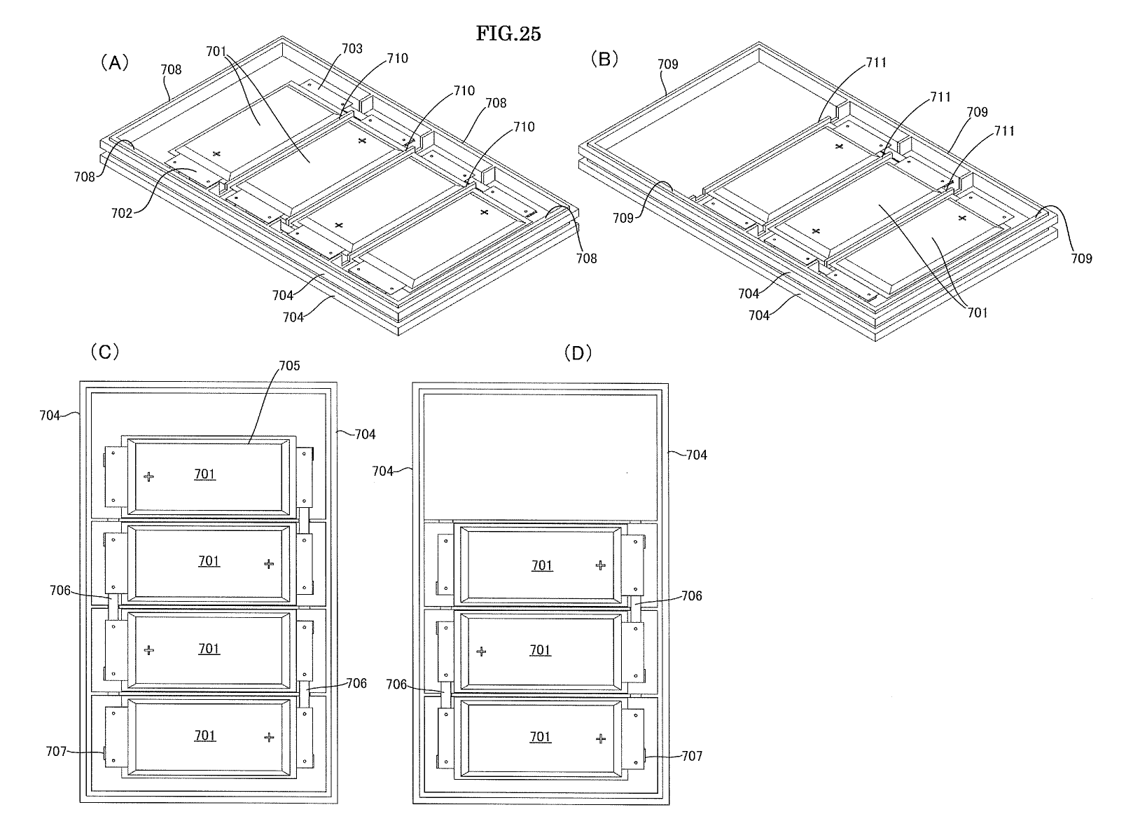

FIG. 25 is a perspective view and plane view of main components of a battery module 700 according to the second embodiment of the present invention.

FIG. 25(A) and FIG. 25(C) are views of the battery module 700 when seen from a first surface's side. FIG. 25 (B) and FIG. 25 (D) are views of the battery module 700 when seen from a second surface's side.

In the battery module 700 of the second embodiment of the present invention, from one end portion of a unit battery 701, a positive electrode pulled-out tab 702 is pulled out; from the other end portion, a negative electrode pulled-out tab 703 is pulled out. That is, unit batteries 701 with two-side tabs are housed.

The battery module 700 can house four unit batteries 701 on one side, or up to eight unit batteries 701 on both sides. However, what is illustrated in the present example is the configuration of the battery module 700 on which seven unit batteries 701 are mounted.

The battery module 701 includes two convex guide members 704 in an upper portion, and two convex guide members 704 in a lower portion. The two convex guide members 704 are fitted into two adjacent concave sections of concave guide members 560 of a module housing rack 550. In this manner the battery module 700 can be inserted into and removed from the module housing rack 550.

In general, in many cases, as a unit battery housed is changed in thickness, the battery module itself is accordingly changed in thickness. However, as described above, if the number of guide members used for the fitting is adjusted, even battery modules that are different in thickness can be housed in the same module housing rack.

Incidentally, as described in detail in the first embodiment, the width of the convex guide members 704 of the present example in the upper portion of the battery module 701 is so formed as to be different from the width of the convex guide members 704 in the lower portion of the battery module 701. Therefore, the inserting or removing of the battery modules 701 into or from the module housing rack 550 in a wrong direction can be prevented.

When unit batteries 701 of the battery module 700 of the second embodiment are connected in series, as shown in FIG. 25, the unit batteries 701 are housed in such a way that a direction in which the positive electrode tab 702 and negative electrode tab 703 of a unit battery 701 are housed is opposite to a direction in which the positive electrode tab 702 and negative electrode tab 703 of a unit battery 701 that is adjacent to the above unit battery 701 within the surface. A bus bar 706 is used to connect the positive electrode pulled-out tab 702 and negative electrode pulled-out tab 703 of a unit battery 701 to the positive electrode pulled-out tab 702 and negative electrode pulled-out tab 703 of a unit battery 701 that is adjacent to the above unit battery 701 within the surface. To connect the first and second surfaces, a bus bar 707, which is similar to the third bus bar 273 used in the first embodiment and which stretches from the first surface to the second surface, is used to connect the first and second surfaces. Therefore, the length of wiring paths can be reduced between the unit batteries.

As in the case of the battery module 400 of the first embodiment, the battery module 700 of the second embodiment includes first surface peripheral partition wall sections 708, second surface peripheral partition wall sections 709, first surface compartmentalization partition wall sections 710, and second surface compartmentalization partition wall sections 711. Therefore, as in the case of the battery module 400 of the first embodiment, it is possible to keep the rigidity of the battery module high. Thus, it is possible to provide the battery module that easily can be made thinner and maintain reliability.

Cover bodies, not shown, that cover battery housing chambers of the battery module 701 can be formed in such a way that battery-pressing raised sections, not shown, press electrode stack regions 705 of the unit batteries 701, as in the case of the first and second cover bodies 310 and 320 of the first embodiment. Therefore, as in the case of the battery module 400 of the first embodiment, deformation of the battery elements can be effectively suppressed. Therefore, it is possible to provide a battery module that easily can maintain excellent battery characteristics such as repeated charge-and-discharge performance.

### INDUSTRIAL APPLICABILITY

The present invention relates to battery modules, such as lithium-ion batteries, which have become increasingly widely used in a field of clean-energy electric storage devices and other fields in recent years. A lithium-ion secondary battery is higher in energy density than other batteries; to ensure safety, an especially high level of flame retardancy is required. The flame retardancy of the batteries can be enhanced by using highly flame-retardant electrode materials. A high level of flame retardancy can also be ensured by improving the configuration of a battery module in which a unit battery is stored. In the battery module of the present invention, a compartmentalization partition wall section that is provided outside a peripheral section of each of the assembled batteries helps to keep abnormal heating or any other trouble of one battery from affecting other batteries. Therefore, it is possible to provide the large-capacity battery module that easily can ensure a high level of flame retardancy. Thus, the industrial applicability is very high.

### EXPLANATION OF REFERENCE SYMBOLS

100: Unit battery
105: Electrode stack region
110: Battery body section
111: Alignment through-hole
115: Insulation tape
120: Positive electrode pulled-out tab
124: Alignment through-hole
130: Negative electrode pulled-out tab
134: Alignment through-hole
135: Through-hole
140: Additional tab member
143: Welding section
145: Through-hole
150: Two-sided tape
200: Unit battery housing body
210: First surface
211: First surface peripheral partition wall section
212: First surface compartmentalization partition wall section
214: Wire-laying notch section
215: First battery housing chamber
216: Second battery housing chamber
217: First surface wiring housing chamber
218: First surface compartmentalization partition wall section
220: Second surface
221: Second surface peripheral partition wall section
222: Second surface compartmentalization partition wall section
224: Wire-laying notch section
225: Third battery housing chamber
226: Fourth battery housing chamber
227: Second surface wiring housing chamber
228: Second surface compartmentalization partition wall section
231: First through-hole
232: First connector
233: Second through-hole
234: Second connector
235: Grip through-hole
236: Grip section
237: Bus-bar-laying through-hole
238: Fuse mounting through-hole
239: Cover-body locking through-hole
240: Unit battery mounting section
241: Unit battery alignment projection
245: Tab member mounting section
246: Tab member fixing screw hole
249: Fuse fixing screw hole
250: First end side protruding guide member
251: Tapered section
252: Tapered section
255: Second end side protruding guide member
256: Tapered section
257: Tapered section
260: Cover body fixing screw hole
271: First bus bar
272: Second bus bar
273: Third bus bar
274: Fourth bus bar
275: Fifth bus bar
281: Power supply line
282: Power line terminal
283: Screw
285: Thermistor connection line
286: Thermistor
287: Sense line
288: Sense line terminal
289: Screw
290 Fuse
310: First surface cover body
311: Battery-pressing raised section
312: Pressing surface
313: Screw hole raised section
314: Screw hole
315: Notch section
316: Locking piece
320: Second surface cover body
321: Battery-pressing raised section
322: Pressing surface
323: Screw hole raised section
324: Screw hole
325: Notch section
326: Locking piece
350: Two-sided tape
360: Cover body insulation sheet
361: Pressing-surface punched section
362: Screw-hole punched section
363: Screw-hole notch section
370: Two-sided tape
380: Pressing-surface insulation sheet
390: Screw
400: Battery module
500: Battery management circuit unit
510: Chassis
511: Bottom surface section
512: Side wall section
513: Screw hole section
515: Ventilation hole
516: Connector
517: Heat dissipation sheet
520: First circuit board
521: Semiconductor component
523: Heat sink
524: Bottom surface section
525: Fin
527: Bolt
528: Nut
540: Second circuit board
545: Screw
550: Module housing rack
560: Concave guide member
590: Housing
600: Electric storage device
700: Battery module
701: Unit battery
702: Positive electrode pulled-out tab
703: Negative electrode pulled-out tab
704: Convex guide member
705: Electrode stack region
706: Bus bar
707: Bus bar
708: First surface peripheral partition wall section
709: Second surface peripheral partition wall section
710: First surface compartmentalization partition wall section
711: Second surface compartmentalization partition wall section

1. A battery module, comprising:
an assembled battery in which a plurality of sheet-like unit batteries are stacked;
a flat-plate base that includes a front surface and a back surface as two main surfaces; and
a peripheral partition wall section that is erected and provided in a peripheral section of the front or back surface from the base, and is formed on both the front and back surfaces, wherein,
in a region formed by the base and the peripheral partition wall section, at least the one assembled battery is housed.

2. The battery module according to claim 1, wherein
the assembled battery is formed by connecting the plurality of sheet-like unit batteries stacked in parallel.

3. The battery module according to claim 1, wherein
the assembled battery is housed in each of the regions provided on the front surface and the back surface.

4. The battery module according to claim 3, comprising
a bus bar through which the plurality of assembled batteries are connected in series.

5. The battery module according to claim 4, comprising
a bus bar that connects at least one assembled battery that is provided on the front surface's side of the base to at least one assembled battery that is provided on the back surface of the base.

6. The battery module according to claim 5, comprising
a protruding guide member that is provided on two side faces that are different from the front and back surfaces and face each other, in such a way as to extend along a planar direction of the front or back surface.

7. The battery module according to claim 6, wherein
the protruding guide member is so provided as to protrude from the peripheral partition wall section or to extend from the base; and a tapered section is so provided that a protruding amount of the protruding, or an extending amount of the extending, varies.

8. The battery module according to claim 7, wherein
a width of the protruding guide member provided on one of the two side faces is different from a width of the protruding guide member provided on the other side face in a direction perpendicular to the front or back surface.
